(19) United States
(12) Patent Application Publication
(10) Pub. No.: US 2013/0086185 A1
(43) Pub. Date: Apr. 4, 2013

(54) SYSTEMS AND METHODS FOR A MULTIMEDIA SOCIAL NETWORKING SYSTEM

(71) Applicant: Sassy Pigeon, Inc., Montreal (CA)

(72) Inventors: Justin DESMARAIS, Montreal (CA); Tony Nimeh, Geneva, NY (US)

(73) Assignee: Sassy Pigeon, Inc., Montreal (CA)

(21) Appl. No.: 13/624,509

(22) Filed: Sep. 21, 2012

Related U.S. Application Data
(60) Provisional application No. 61/538,570, filed on Sep. 23, 2011.

(51) Int. Cl. H04L 12/58

(52) U.S. Cl. CPC H04L 51/32
USPC 709/206

(57) ABSTRACT

The present application is directed to methods and systems for a social networking media system. Users may record brief media messages comprising video and/or audio, via a desktop computing machine, portable computing machine, laptop, tablet, smart phone, or other computing device, and upload the media message to a web provider. Although sometimes referred to as multimedia, in many embodiments, the messages may comprise only audio or only video. Other users of the system may view the media message and record reply media messages, which are similarly uploaded to the web provider. In some embodiments, the message and reply messages may be linked, providing an interactive media-based asynchronous dialogue.

### RELATED APPLICATION

This application claims the benefit of and priority to U.S. Provisional Application No. 61/538,570, entitled “Systems and Methods For a MultiMedia Social Networking System” and filed on Sep. 23, 2011, which is incorporated herein by reference in its entirety for all purposes.

### FIELD OF THE INVENTION

The methods and systems described herein relate generally to social networking systems. In particular, the methods and systems described herein relate to a social networking system integrating multimedia.

### BACKGROUND OF THE INVENTION

Current social networking systems provide text-based interaction, allowing users to communicate with others, comment on recent events, and have back and forth discussions. For example, the website Twitter, by Twitter, Inc. of San Francisco, Calif., allows users to post short public messages, and reply to others' messages. Users can also “follow” other users, or receive updates when any followed user posts a new message. Similarly, the Facebook social networking site allows users to post public messages on a section of a dedicated profile page for another user; reply to or vote for such posts; and otherwise communicate in a publicly observable group-interactive dialogue.

With the advent of networked portable computing devices, such as smart phones and tablet computers, users can be almost continuously connected to such social networking systems, providing brief status updates, commentary, thoughts, reviews, or other messages to other users. For example, through a Facebook application on a smart phone, users can see updates from friends, reply or leave their own status updates, and otherwise interact continuously regardless of their physical location.

Most social networking sites are text-based, however. Status updates and messages are communicated through written means, and as such, tend to be limited by the user's ability or desire to type. For example, users of smart phones may leave only short messages, due to the inefficiency or difficulty of typing on a phone keyboard. Twitter, based on SMS text messaging, even limits users to 140 characters per message. While these sites frequently allow hyperlinks to other content, such as videos hosted on the YouTube media website, provided by Google, Inc., or other media sites, viewing videos require users to leave the social networking site. Additionally, there's a lack of direct interaction between the video sites and the social networking sites, such that any links from the social networking site to the video site are unidirectional.

### SUMMARY OF THE INVENTION

The present application is directed to methods and systems for a social networking media system. Users may record brief media messages comprising video and/or audio, via a desktop computing machine, portable computing machine, laptop, tablet, smart phone, or other computing device, and upload the media message to a web provider. Although sometimes referred to as multimedia, in many embodiments, the messages may comprise only audio or only video. Other users of the system may view the media message and record reply media messages, which are similarly uploaded to the web provider. In some embodiments, the message and reply messages may be linked, providing an interactive media-based asynchronous dialogue.

Unlike text-based messages where the message author is necessarily the originator, in media messages, frequently, a user may record a second person. For example, one person may record a friend telling an amusing anecdote or performing a stunt. To provide enhanced privacy and control, the systems discussed herein allow the media message to be associated, tagged, or otherwise identified with the subject of the media message, such as the friend performing the stunt, even though they are not the user who uploads the message to the media provider. The subject of the message may be identified as the owner, and may have control over publication, deletion, or restrictions such as locking access to the video to a predetermined subset of users. Accordingly, in some embodiments, media content may be generated either by self-filming or self-recording by the originator of the content, or by recording or filming other subjects, and transferring control of the recorded message to the subject. Unlike typical social networking sites in which a first user may ‘tag’ a second user in a photo or video, and the second user may, at most, ‘untag’ themselves, but has no control over publication of the media, the embodiments discussed herein allow the subject to have full control over publication and privacy settings of the media file. In a further embodiment, this control-transfer method may be used to recruit new members to the social networking site. For example, in one embodiment, a member of the site may record a non-member and give them ownership of the recorded message by associating the media message with the non-member's email address, Twitter ID, Facebook ID, or other identifier. In some embodiments, the system may create an inactive account for the non-member associated with the recorded media message. In a further embodiment, the system may notify the non-member that an inactive account has been created for them, and the non-member may connect to the system and log in to activate their account. Once activated, the non-member can control publication of the recorded message, delete the recorded message, lock or unlock the recorded message, or take other actions including recording new messages, replying to existing messages, or other social networking functions.

In some embodiments, the systems discussed herein may allow for hosting and presentation of media files or messages of an extended length, such as one minute, two minutes, three minutes, five minutes, or any other length. For convenience and ease of use, the system may include an automated preview generator that can generate a limited-duration preview of a media file or message, such as 5 seconds, 10 seconds, 15 seconds, or any other length. In one embodiment, the preview generator may select a plurality of segments of a media message or file, each segment comprising a predetermined length, with each selected segment from a different portion of the media message or file, such as the first third, middle third, and last third. In some embodiments, the preview generator may render various transitions between segments, including crossfades or wipes. The resulting preview may be optionally displayed to users prior to, or instead of, the entire media file, allowing a user to quickly and easily determine whether they want to view the entire media file.

In some embodiments, the systems and methods discussed herein provide automated interviews for easy media generation. In some embodiments, an interview engine may play one or more pre-recorded audio and/or video questions to a user. The system may start recording as soon as the question has finished playback, so that the user may respond. When the user finishes answering the question, the recording may stop, either automatically or responsive to a manual command by the user. In a further embodiment, the interview engine may automatically play back additional questions, and the system may record answers. Each answer may be presented as a separate media file, or may be merged into a single interview response file. This may be particularly useful in media profile generation. In some embodiments, the user may be presented with a predetermined list of categories of questions, and, in a further embodiment, may select from the list of categories one or more categories that the user would like to be asked about. In other embodiments, the system may present the user with random questions. In still other embodiments, the user may select one or more categories of questions and topics, or select one or more specific questions, to generate an interview list, and may send the list to one or more other users. The one or more other users may then be interviewed according to the generated interview list from the first user.

In some embodiments, the system may provide a list of featured members to a user, or a list of videos by featured users. In one embodiment, a member may be automatically designated as featured to a user via a matching algorithm matching one or more conditions between the member's profile and the user's profile. For example, a member may indicate that they are within a certain age range, from a certain city, and/or have certain interests. If another user matches one or more of these criteria, the system may present the member as a featured member to the user, thereby providing interest-based networking In some embodiments, the users may request the system to display a specific category of featured users. In other embodiments, a user may request the system to feature the user to specific categories of users. For example, a first user may want to be featured to bankers in New York. If that is the case, and if that request is granted, then the first user may be featured to logged in members who are identified as bankers in New York. This is allows targeted self-advertisement. In some embodiments, users may be asked to pay for the fulfillment of such requests.

In some embodiments, the system may collect playback data, profile visit data, or other data, and present the data to a member. For example, the system may present to a user a graph indicating the number of times that the user's media file was accessed by other users, over time. In other embodiments, the system may provide capability for a user to notify a second user that he or she has visited their profile page or media file. For example, the first user may click a button on a web page or profile page within an application to indicate that the first user has viewed the page. A second user associated with the web page or profile page may then receive a communication indicating that the first user has viewed the page. In some embodiments, these communications may be of limited duration, similar to footprints in sand: the communication that is presented to the second user may disappear after a predetermined time period.

In many embodiments, to facilitate media creation across the web for the benefit of other websites and platforms outside the boundries of the site, a web browser or application plug-in may generate a record button and place the record button on any web page viewed by a user. The record button may be displayed in various locations, including within the web page, in a toolbar, in a pop-up window, in an iFrame, or in any other location. Web pages may be internal or external. In other embodiments, the web page may be pre-programmed with the record button. The user may click the record button to immediately launch a recording window to record input from a microphone and/or camera of the user, allowing the user to leave a media comment on the web page. The comment may be uploaded to the media provider system and displayed for other users. In some embodiments, the comment may include a link to the originating web page. For example, in one embodiment, a record button may be placed on an external third party news website. Visitors of the news website may interact with a record button provided by the web browser or application plug-in to access the recording and hosting functionalities provided by the systems and methods discussed herein. For example, the visitors of the news website may click on “Record”, causing the browser to open an iFrame in a pop-up window allowing the visitors to record and publish a video or audio comment that would may be hosted by the multimedia social networking site. The resulting video may be accessible through the news website through a link as well as through the social networking site directly with a reference link to the originating news article that prompted the comment.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram illustrative of an embodiment of a networked environment useful for the systems and methods described in this document;

FIG. 1B is a block diagram illustrative of an embodiment of a computing machine for practicing the methods and systems described herein;

FIG. 2 is a block diagram of an embodiment of a multimedia social networking system;

FIG. 3 is an illustrated flow diagram of log in to an embodiment of a multimedia social network system;

FIGS. 4A-4B are an illustrated flow diagram, divided across two figures for readability, of various actions from an embodiment of a homepage of a multimedia social network system.

FIG. 5 is an illustrated flow diagram of an embodiment of a method for recording and categorizing a media message;

FIG. 6 is an illustrated flow diagram of an embodiment of a method for recording a pre-categorized media message;

FIG. 7 is an illustrated flow diagram of an embodiment of a method for recording a media message and providing authentication or registration information;

FIG. 8 is an illustrated flow diagram of an embodiment of a method for generating and authenticating active and inactive accounts;

FIG. 9 is a flow chart of an embodiment of another method for generating and authenticating active accounts via a social networking site;

FIG. 10 is a diagram distinguishing embodiments of published and unpublished users;

FIG. 11 is a flow chart of an embodiment of a method of locking, unpublishing, or deleting a media file and controlling publication of the user;

FIGS. 12-20 are screenshots of an example embodiment of an application for a mobile computing device for practicing the systems and methods discussed herein; and

FIGS. 21-42 are screenshots of an example embodiment of a web page for a desktop computing device for practicing the systems and methods discussed herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

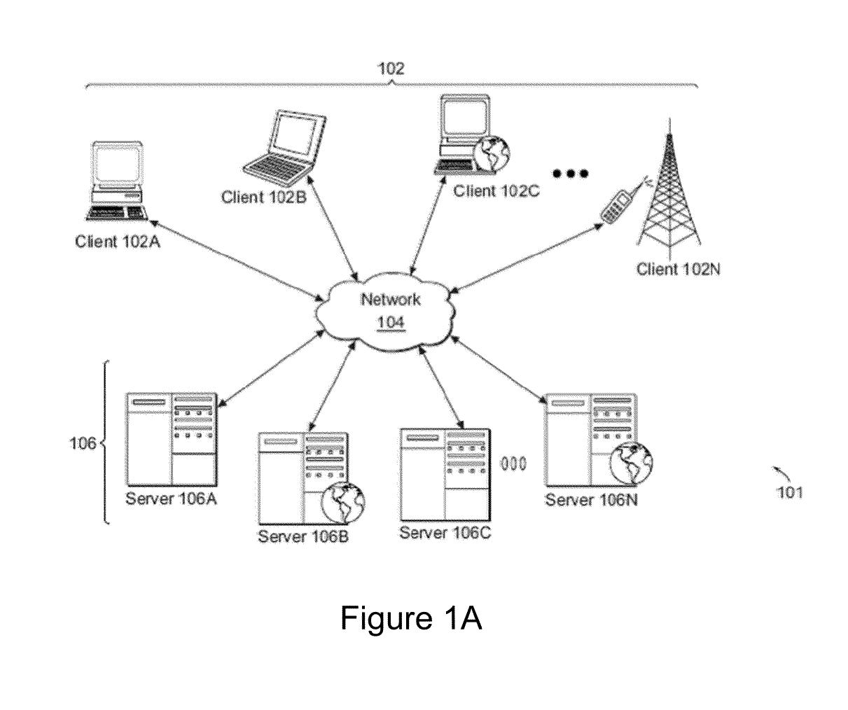

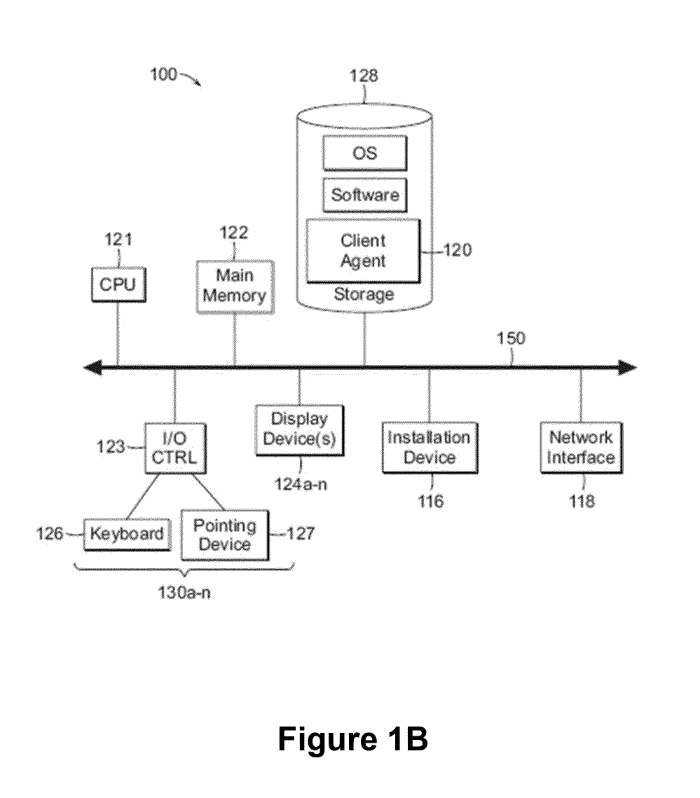

Prior to discussing specifics of a multimedia social networking system, it may be helpful to briefly discuss embodiments of a network environment and computing system useful for practicing the methods and systems discussed herein. FIG. 1A illustrates one embodiment of a networked environment 101 in which a multimedia social networking system can be provided. As shown in FIG. 1A, the networked environment 101 includes one or more client machines 102A-102N (generally referred to herein as “client machine(s) 102” or “client(s) 102”) in communication with one or more servers 106A-106N (generally referred to herein as “server machine(s) 106” or “server(s) 106”) over a network 104. The client machine(s) 102 can, in some embodiments, be referred to as a single client machine 102 or a single group of client machines 102, while server(s) 106 may be referred to as a single server 106 or a single group of servers 106. Although four client machines 102 and four server machines 106 are depicted in FIG. 1A, any number of clients 102 may be in communication with any number of servers 106. In one embodiment a single client machine 102 communicates with more than one server 106, while in another embodiment a single server 106 communicates with more than one client machine 102. In yet another embodiment, a single client machine 102 communicates with a single server 106. Further, although a single network 104 is shown connecting client machines 102 to server machines 106, it should be understood that multiple, separate networks may connect a subset of client machines 102 to a subset of server machines 106.

In one embodiment, the computing environment 101 can include an appliance (not shown in FIG. 1A) installed between the server(s) 106 and client machine(s) 102. This appliance can mange client/server connections, and in some cases can load balance connections made by client machines 102 to server machines 106. Suitable appliances are manufactured by any one of the following companies: the Citrix Systems Inc. Application Networking Group; Silver Peak Systems, Inc, both of Santa Clara, Calif.; Riverbed Technology, Inc. of San Francisco, Calif.; F5 Networks, Inc. of Seattle, Wash.; or Juniper Networks, Inc. of Sunnyvale, Calif.

Clients 102 and server 106 may be provided as a computing device 100, a specific embodiment of which is illustrated in FIG. 1B. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected one or more input devices. As shown in FIG. 1B, the I/O controller 123 is connected to a camera 125, a keyboard 126, a pointing device 127, and a microphone 129.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1B illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (not shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

Embodiments of the computing device 100 include any one of the following I/O devices 130A-130N: a camera 125, keyboard 126; a pointing device 127; a microphone 129; mice; trackpads; an optical pen; trackballs; microphones; drawing tablets; video displays; speakers; inkjet printers; laser printers; and dye-sublimation printers; touch screen; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein.

In other embodiments the computing machine 100 can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device. In yet still other embodiments, the computing device 100 may a smart phone or tablet computer, including products such as the iPhone or iPad manufactured by Apple, Inc. of Cupertino, Calif.; the BlackBerry devices manufactured by Research in Motion, Ltd. of Waterloo, Ontario, Canada; Windows Mobile devices manufactured by Microsoft Corp., of Redmond, Wash.; the Xoom manufactured by Motorola, Inc. of Libertyville, Ill.; devices capable of running the Android platform provided by Google, Inc. of Mountain View, Calif.; or any other type and form of portable computing device.

In still other embodiments, the computing device 100 can be a virtual machine. The virtual machine can be any virtual machine managed by a hypervisor developed by XenSolutions, Citrix Systems, IBM, VMware, or any other hypervisor. In still other embodiments, the virtual machine can be managed by a hypervisor executing on a server 106 or a hypervisor executing on a client 102.

In still other embodiments, the computing device 100 can in some embodiments execute, operate or otherwise provide an application that can be any one of the following: software; an application or program; executable instructions; a virtual machine; a hypervisor; a web browser; a web-based client; a client-server application; an ActiveX control; a Java applet; software related to voice over internet protocol (VoIP) communications like a soft IP telephone; an application for streaming video and/or audio or receiving and playing streamed video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

The computing environment 101 can include more than one server 106A-106N such that the servers 106A-106N are logically grouped together into a server farm 106. The server farm 106 can include servers 106 that are geographically dispersed and logically grouped together in a server farm 106, servers 106 that are located proximate to each other and logically grouped together in a server farm 106, or several virtual servers executing on physical servers. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

Prior to discussing specifics of systems and methods for providing a multimedia integrated social networking system, it may be helpful to briefly define a few terms. As used herein, when referring to a person, a “host” may be a first user who records a video or audio media file of a second user (when not referring to a person, “host” may also be used to refer to a media server hosting one or more media files). Conversely, when referring to a person, a “guest” may be the second user, the subject of the media file. Thus, a host-guest relationship may comprise a host who records a media file of a guest, the guest being the subject of the file. Although the host may be the originator of the file, the guest controls publication of the file, including publishing, unpublishing, locking, unlocking, or deleting of the file. In many embodiments, there may be only a single guest per media file. For example, even if a first host user records a video file of three other users performing a stunt or answering a question, one of the three other users may be designated the guest user, and have control over the file. In other embodiments, each guest appearing in a media file may control a separate copy of the media file. This allows greater search capability when users search by guest name, but reduces privacy and control. In still other embodiments, each guest appearing in a media file may “vote” to democratically control publication of the media file. Thus, a media file may have multiple guests who must vote, either unanimously or via majority or other method, to publish, unpublish, or otherwise control the media file. In some embodiments, different voting methods may be used for controlling the media file in different ways. For example, publishing the media file may require a unanimous vote, while unpublishing the media file may require only a single vote. Deleting the media file may require only a majority vote. In addition to hosts and guests, “fans” comprise users who have opted to follow or subscribe to media files of another user.

In addition to terms referring to people, several other terms have special definitions as used herein. A user's “appearances” may refer to media files with the user as subject that other users recorded, and that the user indicated to publish. Accordingly, appearances represent published media files of a guest recorded by a host. Additionally, when a host records a media file of a guest and uploads the file, associated with the guest, the guest may receive an “invitation” or message indicating that a new appearance has been uploaded for the guest to approve and publish. Conversely, a user's “guest clips” may refer to media files recorded by the user, with other users as subjects. Thus, guest clips represent published or unpublished media files recorded by the user as host, of other guests. While the guest receives an invitation to publish the media file, the host may instead receive a message indicating that the guest clip has been uploaded and transferred to the guest for approval and publication. At such time, the guest clip may be referred to as a “sent clip”. In some embodiments, if a guest deletes a media file, the media file may remain as a “sent clip” by the host. While the host will be able to view the sent clips that he or she originated, lacking ownership or control, the host will not be able to publish the sent clip. This allows guests some measure of privacy to delete or unpublish media files, regardless of the originator's wishes, by granting the guest full control over privacy of the media file as it is available on the site for distribution. In these embodiments, the only way a file can be published or distributed to be viewed by users other than the host and guest is if the guest sets publication or privacy permissions allowing said publication or distribution. Thus, the guest is the only person that has control over the viewership of the file.

A media file, sometimes referred to as a media message, media comment, audio and/or video comment, or similar terms, may be published or unpublished. A published media file is publicly accessible, either to all other members or any member of the public. In some embodiments, a published media file may be accessible to any other registered member of the social network site, while in other embodiments, even non-members of the site may view published media files. Additionally, media files may be locked or unlocked. A media file that is published and unlocked may be viewed by other members or non-members, as discussed above. A media file that is published and locked, however, may be viewed by a subset of other members to whom the owner of the file has granted a key. In some embodiments, a key may comprise a flag, token, identifier, or other association between the owner of a locked file, and a user who has been granted a key. A first user with a key from a second user may view one or more locked media files of the second user. In some embodiments, a user may grant a separate key for each locked media file, allowing, for example, a second user to view a first locked media file but not a second locked media file, and a third user to view the second locked media file but not the first locked media file. In other embodiments, a key may apply to all files of the user, such that a second user may view any files locked by the user. In many embodiments, the key may not be physical or even virtual, but rather a simple list of users to whom a first user has granted access to locked files of the first user. Keys may also be easily revoked. In some embodiments, keys may be granted to circles or groups of users. For example, using the Google+ API provided by Google, Inc. or a similar interface, a user may grant access to a first set of locked files to a first group of members and access to a second set of locked files to a second group of members. Accordingly, the user may have media files shared with intimate friends, different files shared with acquaintances, and a third set of files shared with the public at large.

A user's “blog” may refer to media files that the user recorded of either himself or herself, or of objects or locations. Thus, a user's blog may refer to media files that the user recorded without any guests. Accordingly, while a guest is an owner of a guest clip that an originating host creates, with rights to control the guest clip, any user is an owner of any blog media file that the user originates, with rights to control and publish the blog media file. Finally, a user's “broadcast” may, in some embodiments, refer to the superset of media files comprising the user's appearances, guest clips, and blog. This supset may be displayed in a timeline, with clips ordered chronologically with the most recent clip on top. This reflects that the most recent media files may be the files with the highest importance or relevance to the present moment. Additionally, a user's “feed” may, in some embodiments, refer to the superset of the user's broadcast, as well as broadcasts of the user's guests, broadcasts of the user's hosts, and broadcasts of anyone the user is a fan of.

The methods and systems discussed herein allow members to generate and upload media content about other members, automatically transferring control of the uploaded media file to the corresponding other member that is the subject of the media file. Through this mechanism, members may record non-members and give them ownership of a media file by associating the media file with the non-member's email address or an identifier of the non-member on a social networking site, such as a Facebook ID or Twitter ID. The system creates an inactive account that has ownership and control over publication of the media file. The inactive account may be activated by the non-member when he or she completes his or her registration. Accordingly, non-originating subjects of media files may have ownership or control over media files, publishing the media files for broadcast to other members. This functionality also encourages human networking, as members record non-member friends, encouraging such non-members to join the service by providing already-recorded media files associated with the non-member for publication, reducing the need for the non-member to start building a social networking profile from scratch. This relationship is further preserved during use by retaining the host-guest relationship between content originators and subjects. This dynamic overcomes the typical challenge in online video: how to be recorded by another person yet not be compromised by the lack of control over the resulting media file.

In some embodiments, the systems and methods discussed herein provide automated interviews for easy media generation. In some embodiments, an interview engine may play one or more pre-recorded audio and/or video questions to a user. The system may start recording as soon as the question has finished playback, so that the user may respond. When the user finishes answering the question, the recording may stop, either automatically or responsive to a manual command by the user. In a further embodiment, the interview engine may automatically play back additional questions, and the system may record answers. Each answer may be presented as a separate media file, or may be merged into a single interview response file. This may be particularly useful in media profile generation. In some embodiments, the user may be presented with a predetermined list of categories of questions, and, in a further embodiment, may select from the list of categories one or more categories that the user would like to be asked about. In other embodiments, the system may present the user with random questions. In still other embodiments, the user may select one or more categories of questions and topics, or select one or more specific questions, to generate an interview list, and may send the list to one or more other users. The one or more other users may then be interviewed according to the generated interview list from the first user.

In some embodiments, the systems discussed herein may allow for hosting and presentation of media messages of an extended length, such as one minute, two minutes, three minutes, five minutes, or any other length. For convenience and ease of use, the system may include a preview generator that can generate a limited-duration preview of a media message, such as 5 seconds, 10 seconds, 15 seconds, or any other length. In one embodiment, the preview generator may select a plurality of segments of a media message, each segment comprising a predetermined length of the message, with each selected segment from a different portion of the media message, such as the first third, middle third, and last third. In some embodiments, the preview generator may render various transitions between segments, including crossfades or wipes. The resulting preview may be optionally displayed to users prior to, or instead of, the entire media message, allowing a user to quickly and easily determine whether they want to view the entire media message.

In some embodiments, the system may provide a list of featured members to a user, or a list of videos by featured users. In one embodiment, a member may be automatically designated as featured to a user via a matching algorithm matching one or more conditions between the member's profile and the user's profile. For example, a member may indicate that they are within a certain age range, from a certain city, and/or have certain interests. If another user matches one or more of these criteria, the system may present the member as a featured member to the user, thereby providing interest-based networking For example, a member may indicate that they are within a certain age range, from a certain city, and/or have certain interests. If another user matches one or more of these criteria, the system may present the member as a featured member to the user, thereby providing interest-based networking. In some embodiments, the users may request the system to display a specific category of featured users. In other embodiments, a user may request the system to feature the user to specific categories of users. For example, a first user may want to be featured to bankers in New York. If that is the case, and if that request is granted, then the first user may be featured to logged in members who are identified as bankers in New York. This is allows targeted self-advertisement. In some embodiments, users may be asked to pay for the fulfillment of such requests.

In some embodiments, the system may collect playback data, profile visit data, or other data, and present the data to a member. For example, the system may present to a user a graph indicating the number of times that the user's media file was accessed by other users, over time. In other embodiments, the system may provide capability for a user to notify a second user that he or she has visited their profile page or media file. For example, the first user may click a button on a web page or profile page within an application to indicate that the first user has viewed the page. A second user associated with the web page or profile page may then receive a communication indicating that the first user has viewed the page. In some embodiments, these communications may be of limited duration, similar to footprints in sand: the communication that is presented to the second user may disappear after a predetermined time period.

In many embodiments, to facilitate media creation, a web browser or application plug-in may generate a record button and place the record button on any internal or external web page viewed by a user. In other embodiments, the web page may be pre-programmed with the record button. The user may click the record button to immediately launch a recording window to record input from a microphone and/or camera of the user, allowing the user to leave a media comment on the web page. The comment may be uploaded to the media provider system and displayed for other users. In some embodiments, the comment may include a link to the web page.

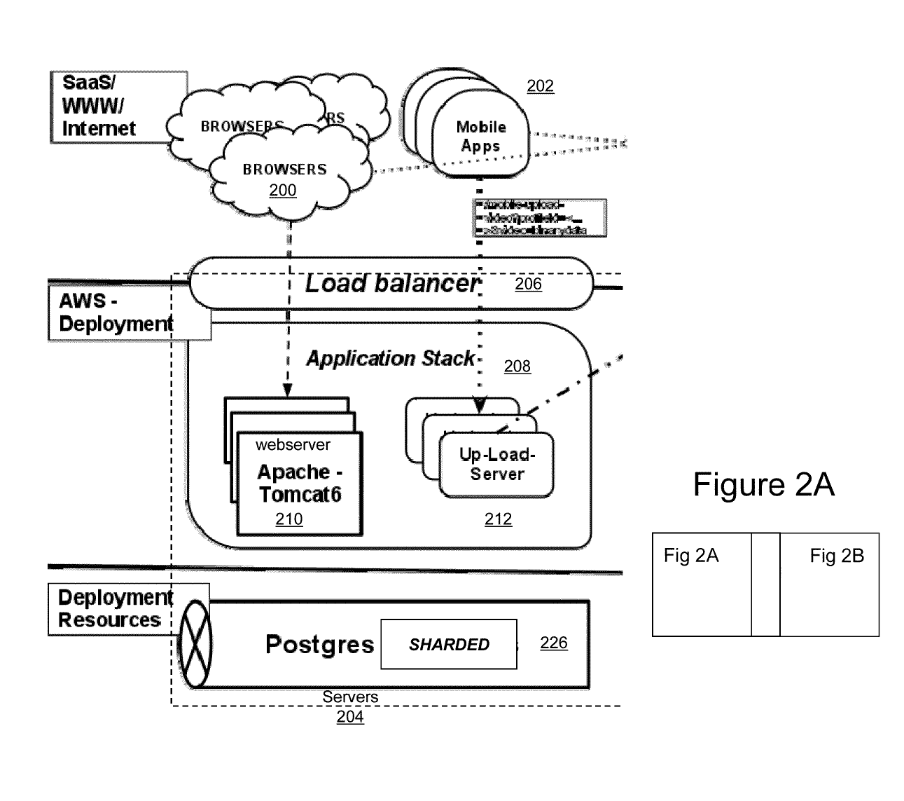

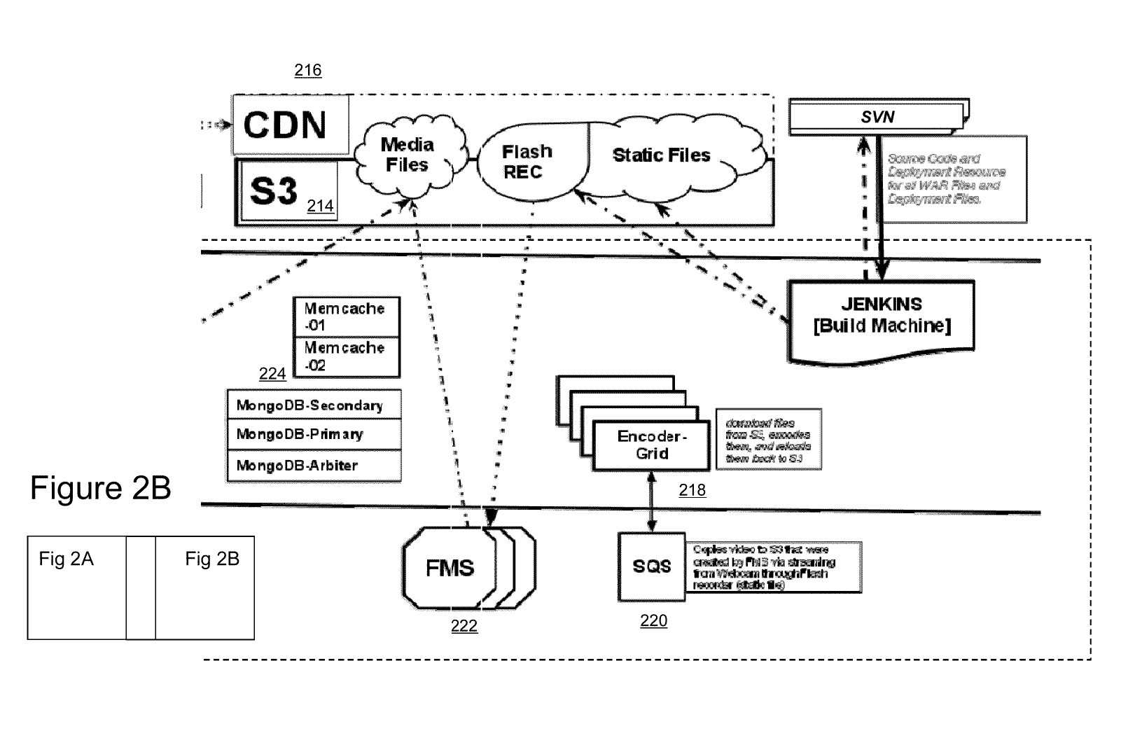

Referring now to FIG. 2, illustrated is a block diagram of an embodiment of a multimedia social network system. In brief overview, one or more client computing devices operating web browsers 200 or other applications, and/or one or more mobile computing devices operating mobile applications 202, browsers, or other applications may connect to one or more servers 204. In many embodiments, browsers 200 and applications 202 may connect via a load balancer 206 to provide scalability. Load balancer 206 may comprise an appliance, server, intermediary device, application, or other entity for routing and balancing requests among a plurality of servers 204. Thus, although illustrated as a single server 204, in many embodiments, one or more components of server 204 may be distributed among a plurality of servers 204, or may be duplicated on one or more additional servers 204.

Servers 204 may include an application stack 208, which may comprise web servers 210 and upload servers 212. Web servers 210 may comprise applications for hosting and providing one or more web pages or access to one or more databases for client-side applications. Databases 224 may comprise one or more scalable document-oriented databases for indexing and querying media files. In some embodiments, databases 224 may comprise one or more database shards 226, providing scalability. A primary database may provide shard keys for queries by web servers 210 or clients to route requests to different shards 226. Web servers 210 may host profile pages, indexes of media files, provide media file database search capabilities, provide control functionality for users allowing users to review, publish, unpublish, lock, unlock, or delete media files. In some embodiments, application stack 208 may comprise one or more authentication or login components (not illustrated). Authentication components may provide login functionality for users, including checking a user's credentials, password, or other identification.

Upload servers 212 may comprise one or more file servers for receiving media files from computing devices or mobile devices of users. Media files may comprise video, audio, audio and video, still images, or other media. In some embodiments, media files may include text, such as captions. In still other embodiments, users may provide text-only messages, such as text replies to other media files. Media files may be in various formats, including MPEG, MP4, AAC, H.264, WMV, PNG, JPG, GIF, FLV, or any other type and form of media file. Media files may be transferred to a storage system 214 such as the Simple Storage Service (S3) provided by Amazon, Inc; content delivery network 216; or any other type of network file storage and delivery service, including cloud-based content delivery systems. In some embodiments, media files may be transcoded by one or more encoders 218. This may be done to provide media files in different formats for various computing devices, such as Apple iOS-based smart phones or tablets, or Google Android-based smart phones. In some embodiments, as part of such transcoding, files may be resized, rotated, have resolution changed, have audio acoustically compressed, equalized, or normalized, or be manipulated in other ways. For example, in some embodiments, some smart phones may not recognize the distinction between portrait mode and landscape mode when recording. Accordingly, while a user may record a video in portrait orientation, for example, the resulting media file may be in landscape orientation with the subject rotated by ninety degrees. In some embodiments, during transcoding, encoder 218 may recognize the video as being rotated, either via one or more items of metadata, by identifying a vertical horizon line in the video that should be horizontal, or via other means, and may rotate the video. In some embodiments, a queuing service 220, such as the Simple Queue Service (SQS) provided by Amazon, Inc. may be used to queue jobs or one or more commands to be executed. For example, a “job” may comprise instructions to “make an .mp4 file from xyz.flv file.” This job may be placed in a queue to be executed by an encoder such as encoder 218. The encoder 218, in some embodiments, may ‘pick-up’ the job or begin execution of the job. If the job is successfully completed, the encoder 218 may notify the queueing service 220 of successful completion and the job may be deleted from the queue. If not, the job may stay available to be picked up by another encoder. To prevent two encoders from picking up the same job, in some embodiments, a job may get locked for a period of time, such as 15, 20, or 30 seconds, while being processed by the first encoder. The first encoder may notify the queueing service that it has begun execution of the job. In some embodiments, when an encoder picks up a job, it may download the media file from the queueing service or a storage location associated with the queueing service to memory associated with the encoder, such as RAM, flash memory, a local hard drive, or any other storage. The encoder may process the media file according to the job instructions. The encoder may then upload the processed or resulting file or files to the queueing service, storage location, or, in some embodiments, directly to the content delivery network.

In some embodiments, servers 204 may comprise one or more recording servers 222. Recording servers 222 may comprise one or more applications, servers, daemons, services, or other executable code for receiving and recording a media stream. Although referred to generally as recording servers, in many embodiments, recording servers 222 may utilize specific streaming engines, such as HTML5-based wrappers; Flash Media Server provided by Adobe Systems, Inc. of San Jose, Calif.; Wowza media servers provided by Wowza Media Systems, Inc. of Evergreen, Colo.; the open source Red5 media server; or any other type and form of media server. Accordingly, recording servers 222 may refer to any server capable of receiving and recording a media stream. As discussed above, in some embodiments, a plug-in, toolbar, application extension, applet, or other script may be provided to a computing device to display a record button while a user views a web page. The user may click on the record button to immediately record a comment on the web page. In some embodiments, clicking the record button may launch a pop-up window which may comprise a script for initializing a web camera or other recording device via Adobe Flash or a similar scripting environment. In a further embodiment, the script may not initiate recording locally on the user's computing device, but may initiate a communication session with recording server 222 comprising a media stream from the user's microphone, web camera, and/or desktop display. Recording server 222 may receive and store the media stream. The media stream may, in some embodiments, be transcoded or encoded into one or more formats by encoders 218, and may be uploaded to a content delivery network 216 by the recording server, encoder, or application server.

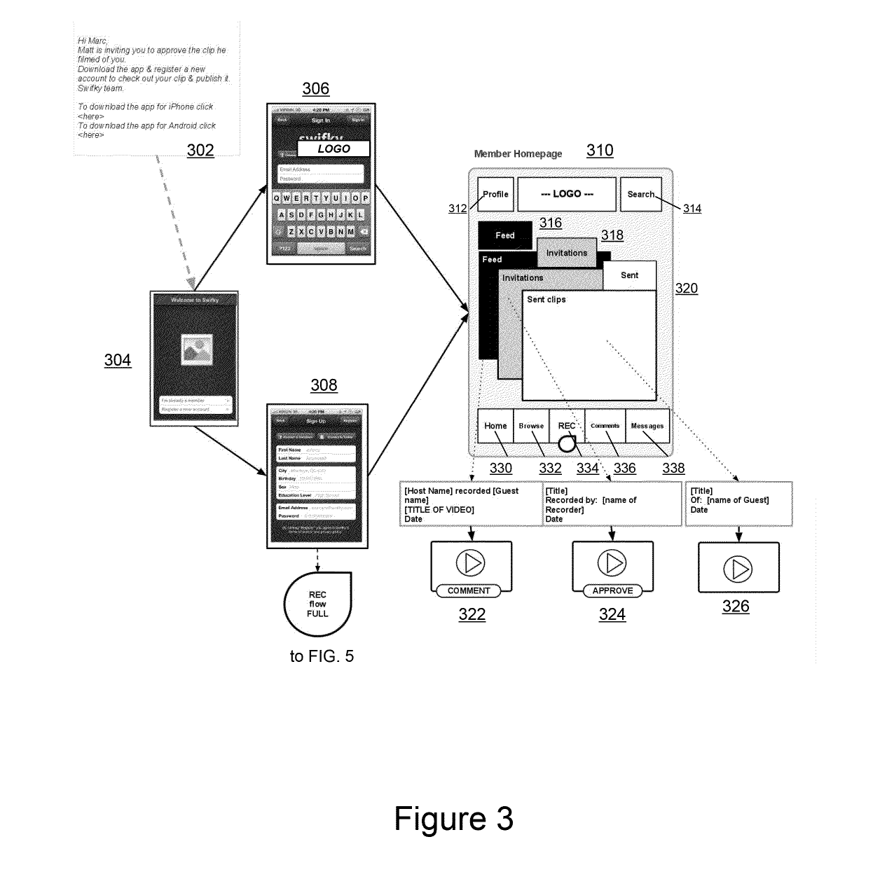

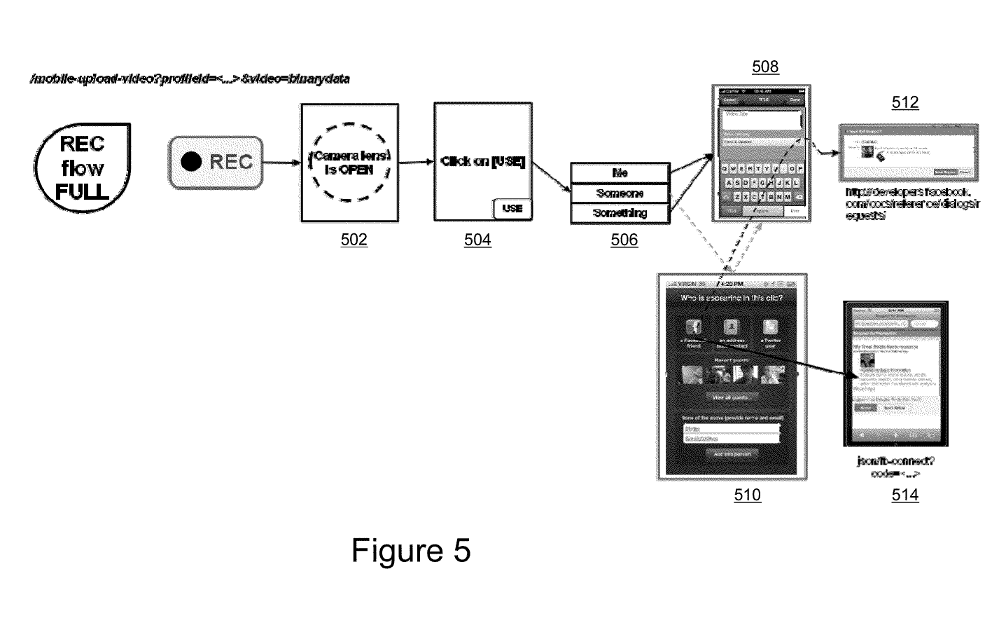

Referring now to FIG. 3, shown is an illustrated flow diagram of log in to an embodiment of a multimedia social network system. In some embodiments, a user (such as a member or a non-member interested in joining the social network system) may navigate to a home page or splash screen 304, which may provide options for log in to an existing account 306 or registration of a new account 308. Although illustrated as an application on a mobile computing device, similar embodiments of screens may be used for web browsers, or desktop or laptop computing devices. In many cases, such screens may be larger, more detailed, or with links rather than buttons. One skilled in the art may readily conceive of similar embodiments for non-mobile devices without departing from the scope of the present invention. In some embodiments, a user may be directed to the splash page via an email message 302. For example, in embodiments in which a host originates a media file of a guest, the guest may receive an email message 302 notifying the guest that a media file of them has been uploaded to the system and asking them to approve and publish the media file. In some embodiments, a newly registered user completing registration 308 may be directed to record a profile video via the record flow discussed in connection with FIG. 5 below.

Once logged in or registered, a member homepage 310 may be displayed to the user. The member homepage may comprise links to a user profile 312; a search page 314 allowing the user to search for profiles or media files; (optionally, for consistency across various screens) back to the homepage 310; a page for browsing media files 332; a direct link to record a media file 334; a page of comments left by the user or other users on media files of the user 336; and messages, including private messages from other users or system messages, for the user 338. Additionally, the home page may display an index of the user's feed 316 (i.e. the user's broadcast, broadcasts of hosts of the user, and broadcasts of the user's fans, as discussed above), as well as any invitations the user has received 318 or clips the user has sent to guests 320. As shown, in some embodiments, the user may rotate between the feed 316, invitations 318, and sent clips 320 via tabs. In other embodiments, a single index or list may be shown and the user may switch between the various indices via buttons or tabs 316-320.

The index of feeds 316 may comprise a chronological list or timeline of media files 322 generated by the user, the user's hosts, the user's guests, or other members the user is a fan of. Each media file 322 may be identified by an originator name, such as a host name, and a subject name, such as a guest name. In embodiments in which the media file 322 is of a non-person subject, the media file 322 may be identified only by the originator name. The media file 322 may further be identified by a title, a category, a duration, a date, a location, or any other type and form of information. In some embodiments, the user may click on the index entry to play back the media file 322, or view a preview of the media file. In a further embodiment, the user may click on a comment button to leave a comment on the media file. The comment may comprise another media file, such as a video or audio comment, or may comprise a text comment.

The index of invitations 318 may comprise a chronological list or timeline of media files 324 generated by hosts, with the user as subject. Each media file 324 may be identified by an originator or host name. In some embodiments, each media file 324 may further be identified by a title, a category, a duration, a date, a location, or any other type and form of information. In some embodiments, the user may click on the index entry to play back the media file 324, or view a preview of the media file. In a further embodiment, the user may click on an approval button to approve and/or publish the media file. In some embodiments, the user may also lock the media file or delete the media file. In some embodiments, the index of invitations 318 may include only media files 324 that the user has not yet approved, while in other embodiments, the index of invitations 318 may include all media files 324 that hosts have sent the user as guest, whether or not the user has published the media file.

The index of sent clips 320 may comprise a chronological list or timeline of media files 326 generated by the user, with other users or guests as subject. Each media file 326 may be identified by a subject or guest name. In some embodiments, each media file 326 may be further identified by a title, a category, a duration, a date, a location, or any other type and form of information. In some embodiments, the user may click on the index entry to play back the media file 326 or view a preview of the media file. As discussed above, where a user originates a media file that is of another user or guest, the guest becomes the owner of the media file and has control over publication of the video. Accordingly, the user may not have the ability to publish or unpublish such media files 326. In some embodiments, media files 326 may be removed from the index of sent clips 326 if the guest deletes the file, while in other embodiments, such media files 326 may remain for the originator to view, even if they cannot publish the file.

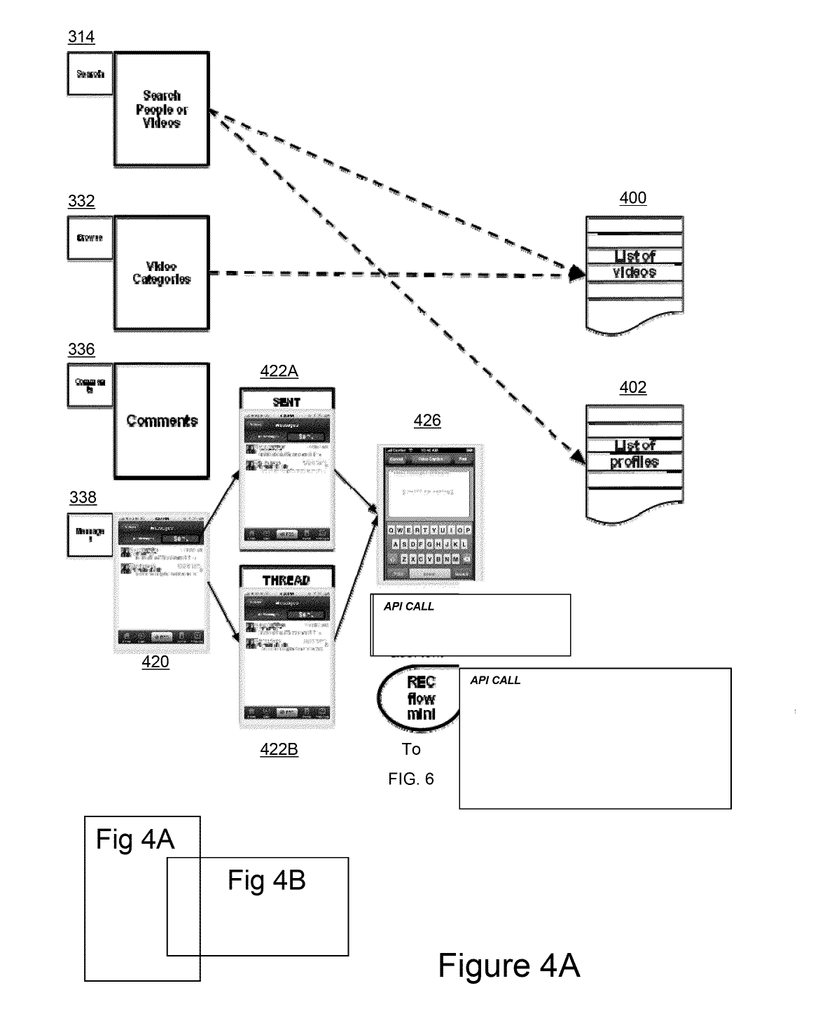

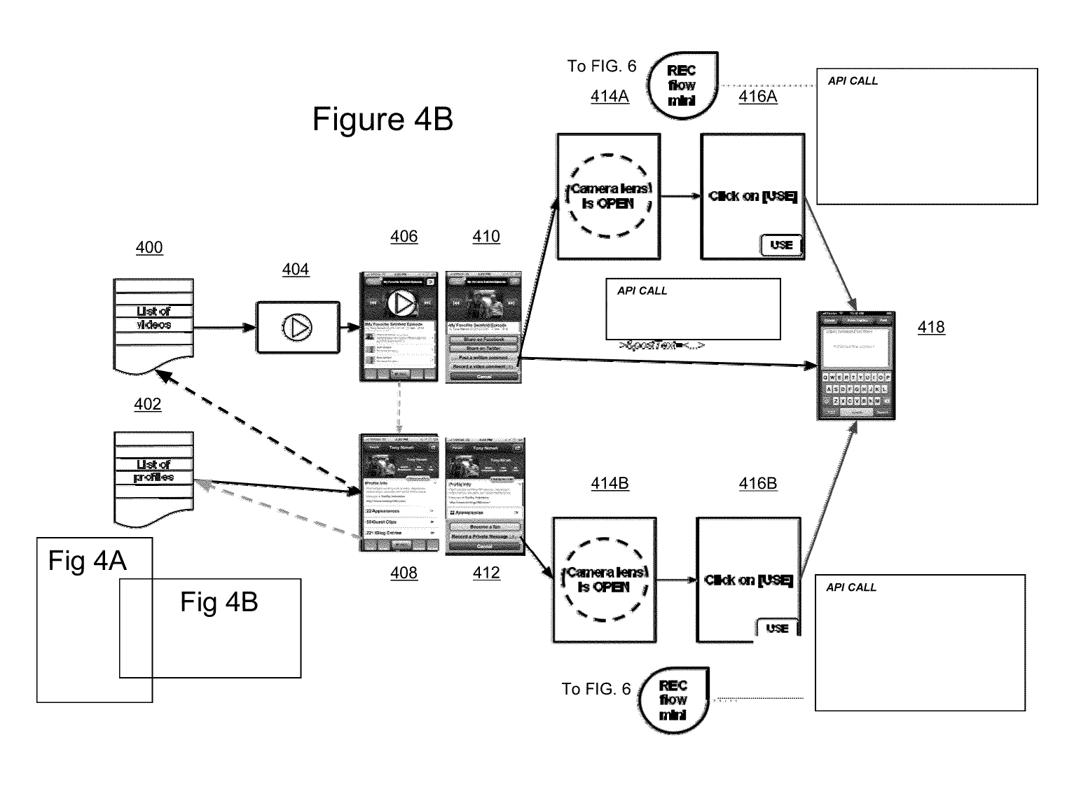

Referring now to FIGS. 4A and 4B, these figures illustrate flow diagrams of various actions from embodiments of a homepage 310 of a multimedia social network system. As shown in the key, FIGS. 4A and 4B overlap with the list of media files 400 and list of profiles 402.

Referring first to the flows for searching 314 and browsing 332 media, in some embodiments, a user selecting search 314 from a homepage or other screen may be directed to search either for people or media files. In some embodiments, the selection of person or media file may comprise checking a checkbox as part of a search screen, selecting a radio button, or via selection of one of two search buttons marked for searching people or media files, respectively. Responsive to the selection, the system may present to the user either a list of media files 400 or a list of profiles 402. The lists 400 or 402 may be filtered based on the user's search. For example, users searching for “tree” may find any media files with a caption or tag matching “tree,” any user profiles with a handle or nickname including the word “tree” or perhaps a profession related to trees, or any other similar filtering criteria. In some embodiments, the lists 400 or 402 may be ordered by relevancy to the search terms, while in other embodiments, the lists 400 or 402 may be ordered chronologically.

Similarly, a user selecting browse 332 from a homepage may, in some embodiments, be directed to select a media file category from a list of predetermined categories. In some embodiments, categories may include “social commentary”, “reviews”, “stories”, “news commentary”, or any other type and form of category. In some embodiments, category selection may be multi-tiered. For example, a user may first select “person” and then be provided with a list of categories of topics that a person may discuss. Conversely, a user may first select “object” and be provided with a list of categories of objects that a user may wish to record a media file about, such as animals, art, food, architecture, cars, or any other type and form of object. In some embodiments, category selection may comprise a hybrid of tiers, allowing a user to select from a plurality of topics that a person may discuss or an additional topic of “object”, selection of the latter leading to a further selection of object topics. This may be more efficient for the majority of users. As shown, responsive to selecting a category, the system may present the user with a list of media files 400 filtered by the selected category. As discussed above, in many embodiments, the list 400 may be ordered chronologically.

Continuing with both flows via the list of media files 400 and profiles 402 on FIG. 4B, and starting with the list of media files 400, a user may select a media file for playback 404, which may be presented to the user either in a window or full screen, depending on selected preferences and device capability, or may be played back via headphones or speakers, if the media file is an audio file. As discussed above, in many embodiments, the user may view and/or listen to previews of media files by selecting the media file in the list of media files 400 or by selecting a preview button associated with each media file. Once the user has viewed or listened to the media file, the system may present a post-playback landing screen 406, which may comprise buttons for replaying the media file, or selecting a next or previous media file in the list of media files 400. The user may also view one or more comments that other users have left, associated with the media file. In many embodiments, comments may be text, while in other embodiments, comments may also be media files. For example, and discussed in more detail below, after viewing a media file, a user may record a short reply message to the user appearing in the media file. The reply message may be uploaded as another media file and associated with the first media file as a comment, appearing in a list of comments. This allows for an asynchronous media-based dialogue between multiple users. Additionally, in some embodiments, from the landing screen 406, a user may select to view a profile of the user owning or controlling the previously played back media file. As discussed above, in embodiments in which a first user as a host uploads a video of a second user as a guest, the guest user may be considered to own or control the media file. Accordingly, in such embodiments, the user may view the profile of the guest user. In other embodiments in which the media file is owned by the originator, such as a blog post or recording of a non-person subject, the user may view the profile of the originating user.

From the post-playback landing screen 406, a selected user profile may be viewed on a profile page 408. Similarly, from the list of profiles 402, a first user may select a profile to view on profile page 408. The profile page 408 may comprise an identification of a second user, such as a name; a description of the user, such as a brief summary, biography, or other details including location, age, gender, industry, title, or any other information; and an identification of the number of appearances and blog entries the second user appears in or guest clips of other users the second user has generated. As shown, in some embodiments, the first user may select appearances, blog entries, or guest clips, and the system may generate and display a corresponding list of media files 400 filtered by the second user and the selected appearance/blog/guest clip criteria. Similarly, in some embodiments, the first user may select guest clips or appearances, and the system may display a list of profiles 402 of other users appearing in the guest clips or who originated the appearances in which the second user appears. Steps 400-408 may be accordingly repeated via different loops as shown.

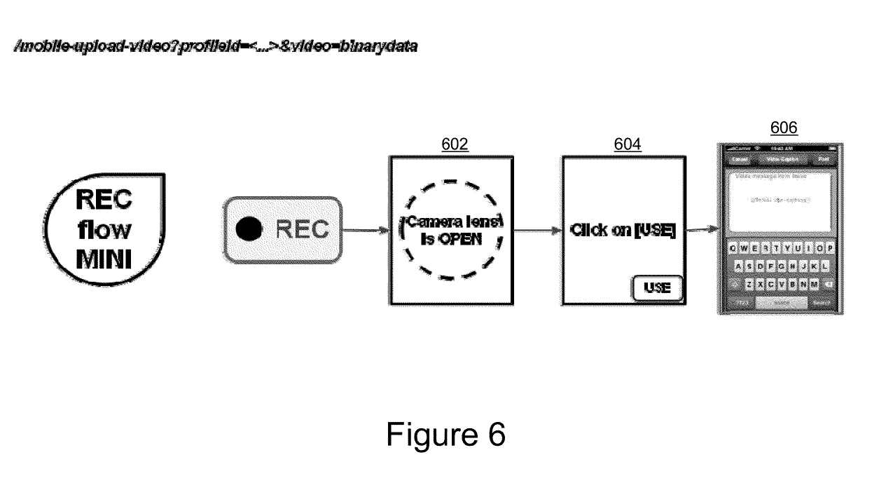

After viewing a media file and landing at post-playback landing page 406, in some embodiments, a user may take further action from a list of actions 410. Actions may include sharing a link and/or comment about the video on a social networking site such as Facebook, LinkedIn, Twitter, Google+, MySpace, or any other type and form of social networking site. In some embodiments, the user may post a written comment via a text entry screen 418 to be associated with and displayed to other viewers of the media file on the landing page 406. In still other embodiments, the user may decide to record a media message to be associated with and displayed to other viewers of the media file, as discussed above. Responsive to the user selecting to record a media message, the user's computing device may initiate quick recording via a camera and/or microphone 414a, described in more detail in connection with FIG. 6 below. Once complete, the user may, in some embodiments, review the recorded media message, edit the message, re-record the message, discard the message, or approve or select to use the recorded media message via a review and approval screen 416a. In some embodiments, the user may be prompted to provide a text comment or caption in addition to the media message via a text entry screen 418.

Similarly, after viewing a profile of a second user, a first user may select to take further action from a list of actions 412. In some embodiments, the first user may select to become a fan of the second user. As discussed above, once the first user has indicated they are a fan of the second user, media files of the second user comprising the second user's broadcast may be added to the first user's feed. In other embodiments, the first user may select to record a private message to the second user. Responsive to the user selecting to record a private media message, the user's computing device may initiate quick recording via a camera and/or microphone 414b, described in more detail in connection with FIG. 6 below. Once complete, the user may, in some embodiments, review the recorded media message, edit the message, re-record the message, discard the message, or approve or select to use the recorded media message via a review and approval screen 416b. In some embodiments, the user may be prompted to provide a text comment or caption in addition to the media message via a text entry screen 418. Unlike the public message recorded via 414a-416a which may be added as a media file, associated with a previously-viewed media file, and publicly searchable and indexed, the private message may be delivered only to the second user.

Returning to FIG. 4A, a first user selecting comments 336 from a homepage may be presented with one or more public comments that other users have left after viewing media files generated or owned by the first user, as discussed above in connection with steps 414A-416A. In some embodiments, comments may be sorted chronologically, allowing the first user to view recent comments that others have left on his or her media files.

Similarly, a first user selecting messages 338 from a homepage may be presented with a list of private messages 420. Similar to email messages, private media messages which may comprise audio, video, and/or text may be privately sent between users. In some embodiments, the system may retain track of conversations in a threaded view 422B. The first user may also view messages the user has sent to other users in a sent messages view 422A. In some embodiments, the first user may reply to a received message, add a follow-on reply to a sent message, or may generate a new message to be sent. In one embodiment, responsive to a user selection to record a new message, the system may present a text entry and/or caption input screen 426. The user may generate an optional caption for a media message or may enter text to be sent. The user may then record a quick message, discussed in more detail below in connection with FIG. 6.

Referring now to FIG. 5, illustrated is a flow diagram of an embodiment of a method of recording and categorizing a media message. Responsive to a request from a user to record a media message, at step 502, a computing device may initiate recording. In some embodiments, recording may be via a video camera, microphone, and/or screen scraping or capture of display output. In many embodiments, as discussed above, recording may be limited to a predetermined duration, such as three minutes, or may be stopped manually by the user at any time prior to the predetermined time limit. At step 504, the user may, in some embodiments, review the recorded media message, edit the message, re-record the message, discard the message, or approve or select to use the recorded media message via a review and approval screen 504. When generating a new media message, the user may be prompted to identify the subject of the recording 506: whether the subject is the user (i.e. the media message is a blog post); whether the subject is another person (i.e. the user is a host generating a guest clip); or whether the subject is of an non-person object (i.e. the media message is a blog post that will be categorized as a non-person message). If the subject is the user or a non-person object, at step 508, the user may be prompted for a text caption for the message and a category, selected from a list of predetermined categories. As discussed above, in some embodiments, the system may have different predetermined categories for media messages with a person as the subject and media messages with an object as the subject. Accordingly, the list of predetermined categories may be selected responsive to the identified subject at step 506.

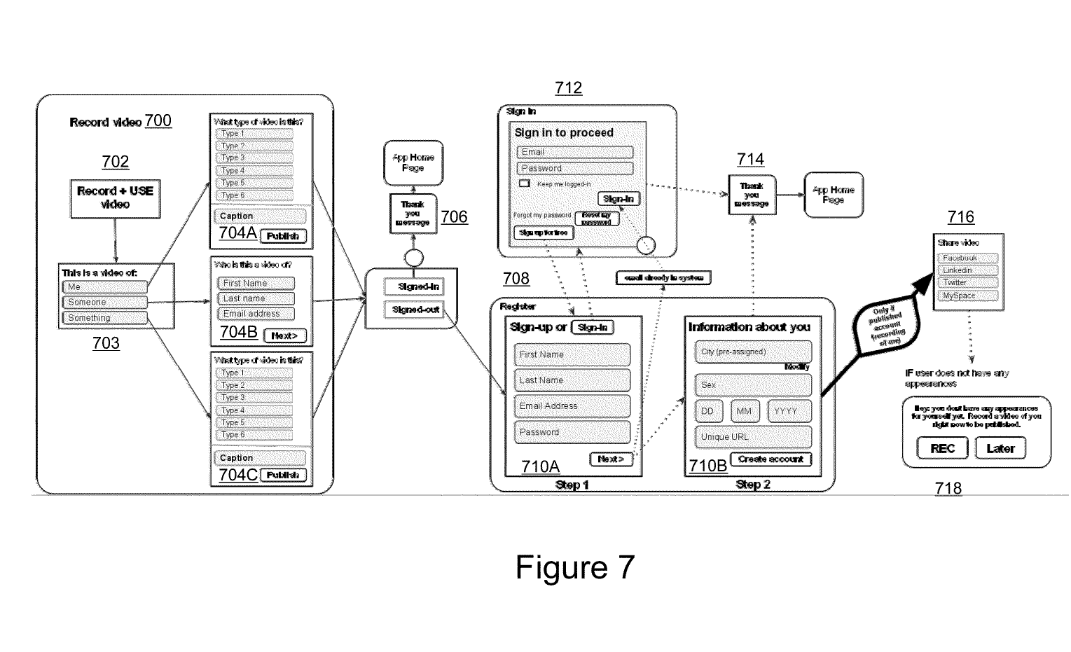

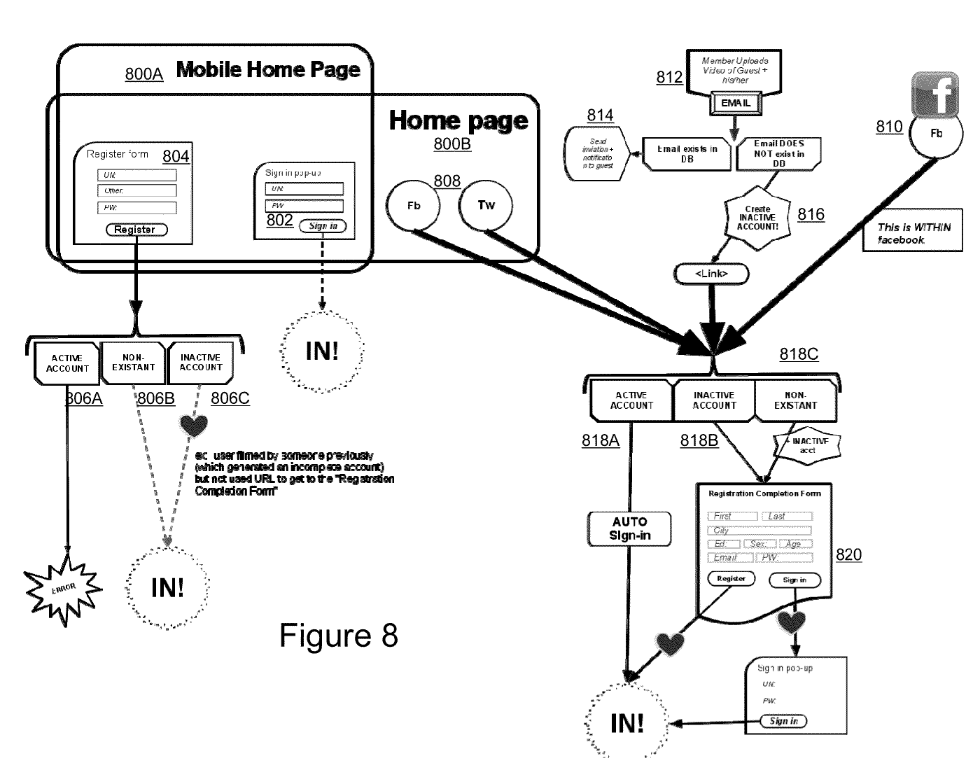

In some embodiments, if the user identifies another person as the subject at step 506, at step 510, the user may be presented with options to identify the individual appearing in the media message. The options may include selecting a linked user or friend on a social networking site such as Facebook, Twitter, Google+, LinkedIn, or any other social networking site; selecting an individual identified in an address book of the user, such as a smart phone's address book or an address book associated with an email application on the user's computing device, such as Outlook, provided by Microsoft Corp.; selecting from a list or icon view of a number of recently selected guest users; selecting from a list of all guests of whom the user has previously created guest clips; or may include adding a name and email address of a guest for whom the user has not previously created a guest clip. In some embodiments, the guest may have been a guest of another user of the system, and may already have an associated member account. In other embodiments, the guest may be new, and an inactive member account may be generated, as discussed below in connection with FIGS. 7-8. In some embodiments in which the user selects a linked user on a social networking site, the system may present a request to the user for permission 514 to access the user's account on the social networking site to retrieve a list of linked users or friends. Once permission has been granted and the user has selected a friend as a guest, the system may generate and send a notification to the friend 512, informing the friend that a media file associated with them has been uploaded for them and requesting permission from the friend to publish the media file. In many embodiments, the user may provide a suggested caption for the guest's media file. However, as the media file is not published prior to the guest's approval, the guest has the ability to modify or replace the caption prior to publication.

FIG. 6 is an illustrated flow diagram of an embodiment of another method of recording a pre-categorized media message, sometimes referred to as quick recording. Similar to the method discussed above in connection with FIG. 5, responsive to a request from a user to record a media message in reply to another media message or as a private message to another user as discussed above, at step 602, a computing device may initiate recording. In some embodiments, recording may be via a video camera, microphone, and/or screen scraping or capture of display output. In many embodiments, as discussed above, recording may be limited to a predetermined duration, such as three minutes, or may be stopped manually by the user at any time prior to the predetermined time limit. At step 604, the user may, in some embodiments, review the recorded media message, edit the message, re-record the message, discard the message, or approve or select to use the recorded media message via a review and approval screen 604. At step 606, the user may provide a caption or other text associated with the recorded message. The system may then either publish the recorded message associated with a media file to which the user is responding, or may send the recorded message as a private message to another user. In some embodiments in which a media file is locked, messages recorded in reply to the media file may also be locked by default, preventing inadvertent disclosure of a private conversation through publication.

Referring now to FIG. 7, shown is an illustrated flow diagram of an embodiment of a method of recording a media message and providing authentication or registration information. In brief overview, a user may record and categorize a new media message at step 700 and transfer the media message to the multimedia social networking system. If the user is currently logged in or authenticated to the multimedia social networking system, the system may inform the user at step 706 that transfer was successful, and may either publish the media message (if the subject is the user or an object) or notify a guest that a media message with them as the subject has been uploaded, as discussed above. If the user is not logged in or authenticated, the user may sign in at step 712 or register a new account at step 708. Once registered or logged in, the system may inform the user at step 706 that transfer was successful, and may either publish the media message (if the subject is the user or an object) or notify a guest that a media message with them as the subject has been uploaded, as discussed above. In some embodiments, if a newly registered user at step 708 has transferred a media message of themselves or an object, the message may be immediately published, and the user may be given options to share the recorded media message via other social networking sites at step 716, and, in some embodiments, asked to generate a media profile recording at step 718.

Still referring to FIG. 7 and in more detail, at step 700, encompassing steps 702-704C, a user may record and categorize a media file. At step 702, the user may record the media file using any of the methods and systems discussed above, such as through a web browser plug in or extension, via a stand alone application, or via any other means. In some embodiments, the user may record the media file separately and upload the media file via a file transfer interface. In some embodiments, the user may review the media file, edit the media file, re-record the media file, or perform other functions before approving or using the media file. In some embodiments, responsive to using or approving the recorded media file, the media file may be transferred to the system or to storage associated with the system, such as a content delivery network or online storage environment.

At step 703, in some embodiments, the user may be asked to identify the subject of the media message. As discussed above, the media message may have the user as a subject, another user as the subject, or an object as the subject. In other embodiments, the media message may be pre-categorized, as when the user records a media message in reply to another media message or profile. In some such embodiments, steps 703 and 704A-704C may be skipped.

Responsive to the user identification of the subject at step 703, the system may request further categorization at steps 704A-704C. In step 704A, responsive to the user identifying themselves as the subject of the media message, the user may be prompted to provide a category from a predetermined list of categories and a caption for the media message. The user may then be prompted to publish the message. Similarly, in step 704C, responsive to the user identifying an object, such as an animal, car, building, or other scene or object, as the subject of the media message, the user may be prompted to provide a category from a second predetermined list of categories and a caption for the media message. The user may then be prompted to publish the message. Conversely, at step 704B, responsive to the user identifying that another user or guest is the subject of the message, the user may be prompted to provide a name and/or email address of the guest.

If the user is signed in or authenticated to the system, at step 706, the user may be notified that the message has been transferred. In some embodiments, the user may be returned to a homepage, as discussed above. If the transferred message was of the user or an object, the message may be published. If the transferred message was of another user or guest, the guest user may be notified that a new media message of them has been uploaded for review and publication.

If the user is not signed in or authenticated, at step 708, the user may be prompted to sign-up or sign-in. In some embodiments, if the user selects to sign-in, the user may be prompted at step 712 to provide an email and password or other identification and authentication credentials. Once signed-in, at step 714, similar to step 706, the user may notified that the message has been transferred, and the message may be published or a guest notified.

If the user selects to sign-up, at steps 710A-710B, the user may provide credentials including name, email, password, location, age or date of birth, gender, webpage, social network login or account name, industry, job title, or any other type and form of information. A new member account may be created for the user, identified via the provided credentials. If the transferred message was of another user or guest, the user may be notified that the message has been transferred at step 714 and the guest notified. Conversely, if the transferred message was of the user or an object, the media message may be published and associated with the new member account for the user. At step 716, the user may be prompted to share the newly published message via a social networking site, ideally prompting sign up of additional users to the system. In some embodiments, if the media file is of the user, the media file may be added as a profile media file for the user's member account or the user may be prompted to add the media file as a profile media file. A user's profile media file, as discussed above, may be viewed when another user selects to view the user's profile. If the media file transferred at step 700 is of a subject, then in some embodiments, at step 718, the user may be prompted to record a profile media file or blog post with the user as subject to be placed as the user's profile media file.

Referring now to FIG. 8, shown is an illustrated flow diagram of an embodiment of a method for generating and authenticating active and inactive accounts. Prior to discussing specifics of the method, it may be helpful to first distinguish between active, inactive, and non-existent accounts. Non-existent accounts have not been created and are accordingly not associated with any media files, users, members, guests, hosts, or other entities. Active accounts have been created and are associated with specific member users. Each active account may be further associated with the account user's media files, hosts, and guests, as well as other members the user is a fan of or other members who are fans of the user. Inactive accounts are existent, but not active: an inactive account is created when a user records and transfers a media message with a second user as a subject, the second user not a member/not having an associated active account. Accordingly, the inactive account is a placeholder for the second user to create an account. Media files, such as the file that caused the inactive account to be generated, may be associated with the inactive account. When the guest user eventually activates the account by providing registration credentials, the user's account is still associated with the media files. This advantageously allows media files of guests to be “owned” by the guest, even before the guest has connected to the multimedia social network system.

Still referring to FIG. 8, a user may log in via a home page of the social networking site, via an application, via a pop-up authentication window, via a link in an email or SMS message, or other means. In some embodiments, different home pages 800A-800B may be presented to the user, responsive to capabilities of the user's device or other credentials and/or cookies available to the system. For example, where an authentication cookie for a social networking site such as Facebook or Twitter exists on the user's computing device, at step 808, the system may use authentication credentials retrieved from the cookie, such as email or account name, to identify an associated active or inactive account or determine that no associated account exists. At step 802, if an active account exists for the user, the user may simply sign in by providing authentication credentials.

Conversely, at step 804, the user may provide registration information to the system. If the registration information is associated with an already-active account 806A, such as the user entering an email address for registration that is already associated with an active account, the system may indicate that an error has occurred, or that the account already exists. If no account exists, then at 806B, in some embodiments, an account may be generated for the user and associated with the user's credentials supplied at step 804, and the user may be signed in to the system. If an inactive account exists, such as an account that is associated with a media file previously transferred to the system, in some embodiments, the account may be made active and associated with the credentials provided by the user.

In addition to retrieving authentication information from cookies, in some embodiments, the sign-in or registration form may be provided as an applet or plug-in within a social networking site, such as a Facebook App. Users of such apps are already identified via their login to the social networking site. Accordingly, the user's login credentials may be transferred to the multimedia social networking system at step 810.

In other embodiments, such as at step 812 where a host has transferred a file with a guest as a subject for whom no active account exists, the host may provide an email address of the guest, as discussed above. If an identification of the email address exists in the system database, then an inactive account has already been generated for the user. Accordingly, at step 814, an invitation to register and notification of the new media message may be sent to the guest at the provided email address. If an identification of the email does not exist in the system database, then the system may generate an inactive account at step 816 and link the account to the media file provided by the host. The system may further send an invitation to register and notification of the new media message to the guest at the provided email address.

At step 818A, responsive to user credentials from the social networking site and/or cookies, in some embodiments, the system may automatically log in the user. At step 818B, if the user is associated with an inactive account (i.e. the user is a guest already associated with a transferred media file), the user may be automatically sent to a registration completion form. For example, the user may click on a link in an email sent to the user at steps 814 or 816, and thus be already identified to the system via a code, such as a unique parameter code in a parameter field of the URL of the link. Accordingly, the system may automatically identify the user as associated with the inactive account, and may prompt the user to complete registration at step 820 and log in the user.

Similarly, at step 818C, the user may be automatically identified via cookies and/or social network account logins, but not be associated with an active or inactive account. An inactive account, associated with no media files, may be generated for the user, and the user may be prompted at step 820 to complete registration and log in.

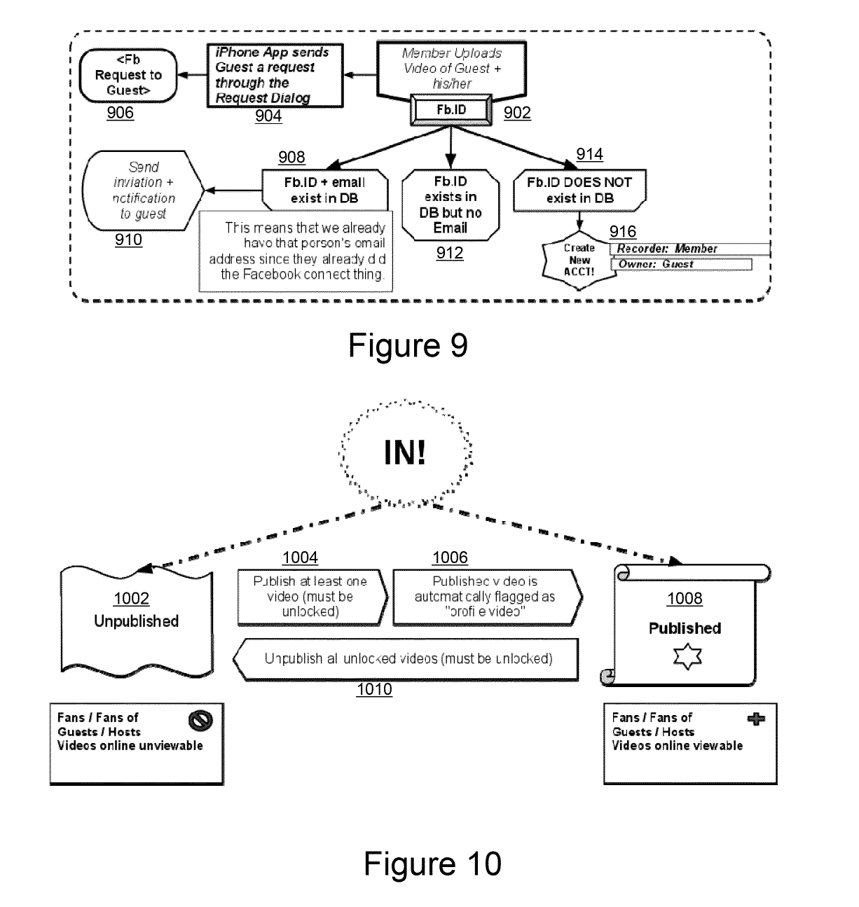

Referring now to FIG. 9, illustrated is a flow chart of an embodiment of another method for generating and authenticating active accounts via a social networking site. The Facebook social networking site is used as an example, but one of skill in the art may readily apply the same methods and systems to other social networking sites. At step 902, a member may upload a media file of a guest and include a social network account identifier for the guest, such as a Facebook ID. At step 904, in some embodiments in which the member is using a smart phone application to upload the media file, the application may send a request via the Facebook API or similar social network API to the guest to register for the multimedia social network service and approve and publish the video at step 906, as discussed above.

In other embodiments, the service may check an account database for an account associated with the social network account identifier. If the social network account identifier is associated with an email address at step 908, then the identified user must have previously registered and provided an email to the system. The system may send an invitation and notification to the identified guest at the identified email address at step 910, notifying the guest that a media file has been uploaded for them to approve and publish.

Conversely, at step 912, in some embodiments, the social network account identifier may be associated with an account in the account database, but may not include an email address. This may be because a host has previously uploaded one or more media files for the guest, identified by the social network account identifier, and a corresponding inactive account has been created (as at step 916 discussed below), but the guest has not yet registered or the host has not provided an email. In some embodiments, the system may send a message via the social networking site, such as a Facebook application request, to the identified social network account to register the inactive account as active and associate the account with an email address, as well as approving and publishing one or more media files of the guest.

At step 914, if the social network account identifier does not exist in the account database, then at step 916, a new inactive account may be created for the user, identified with the social network account identifier. As discussed above, in some embodiments, the system may send a message via the social networking site, such as a Facebook application request, to the identified social network account to register the inactive account as active and associate the account with an email address, as well as approving and publishing one or more media files of the guest.

Referring now to FIG. 10, illustrated is a diagram distinguishing embodiments of published and unpublished users. Just as a media file may be published or unpublished (or removed from publication), an active user or member account may be published or unpublished. A published active user 1008 has at least one published media file. Conversely, an unpublished active user 1002 has no published media files. As discussed above, a new user who joins the system as a guest after another user has recorded a media file with them as the subject may have an active account associated with an unpublished media file. Accordingly, the account is likewise unpublished 1002. Because the account is unpublished, in some embodiments, the “empty” account will not show up in user searches, fans' lists of users, identification of guests or hosts, or other user lists. The account may remain active, however, allowing a user who has removed media files from publication to re-publish their account and resume placement on fan/host/guest lists. Initial publication or re-publication of the account may be achieved through publication of at least one unlocked (i.e. public) media file at step 1004. At step 1006, the newly published media file may be flagged or designated as the account's profile media file, viewable to users who visit the associated profile page. The account may then be considered a published account 1008, and may appear in searches and in host/guest/fan lists.

Conversely, if a user wishes to remove their account from publication, the user may unpublish all unlocked media files at step 1010 or, in some embodiments, lock any unlocked media files. When no unlocked, published media files remain, the system may unpublish the user's account.

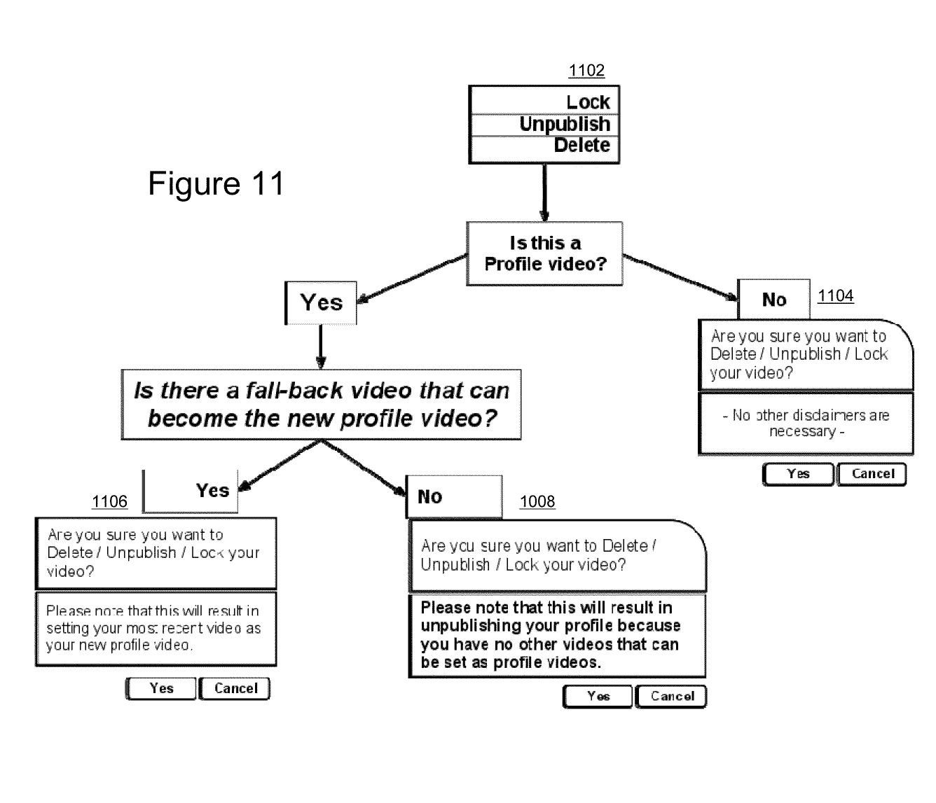

Referring now to FIG. 11, illustrated is a flow chart of an embodiment of a method of locking, unpublishing, or deleting a media file and controlling publication of the user, as discussed above in connection with FIG. 10. At step 1102, a user may unpublish, lock, or delete a previously unlocked, published media file. If the media file is not the user's profile media file, then in many embodiments, another unlocked, published media file necessarily exists for the user. Accordingly, at step 1104, after receiving confirmation, the system may unpublish, unlock, or delete the media file as the user requests, without needing further action regarding the user account.

Conversely, if the media file is a profile media file, the system may determine if a fall-back media file exists that can become the new profile media file. A fall-back media file may comprise a media file that is not the profile media file, but is similarly unlocked and published. If so, at step 1106, the system may seek additional confirmation and notify the user that unpublishing, locking, or deleting the profile media file will result in setting the user's most recent media file as the new profile media file. Once confirmed, the system may proceed accordingly and set the most recently uploaded media file as the profile media file.

If no fall-back media file exists, then at step 1108, the system may seek additional confirmation and notify the user that unpublishing, locking, or deleting the profile media file will result in unpublishing the user's account, as discussed above in connection with FIG. 10.

As discussed above, a published clip is one that all other members and the public can see when they come to a user's profile page. Other members can click on the clip and it will start playing. Conversely, an unpublished clip is one that is still part of the user's account but is hidden from everyone but the user. In some embodiments, it may be marked or identified as unpublished, such as via a grey watermark that says “unpublished”. While the user can see the clip, playback the clip, or publish the clip, other users will not be able to see the clip or play it.

As discussed above, a locked clip is one that is no longer public. The locked clip will only be visible to members who have been granted keys, sometimes referred to as keyholders. Keyholders of the user can click on locked clips to play them like they would any other clips. However, locked clips are invisible (hidden) to members who don't have the user's key. In some embodiments, locked clips may be identified by a padlock symbol. This identification may, in some embodiments, only be visible to the clip owner, rather than keyholders. Accordingly, in some embodiments, locking and unlock may be performed transparently to a keyholder. For example, a first user may grant a second user a key, but not grant a third user the key. The first user may have several media files (files A-C) that are unlocked and several media files (filed D-F) that are locked. In one embodiment, the second user may see all of the first user's media files (files A-F) without any identifying symbols, while the third user may only see the published unlocked files (files A-C). Accordingly, while users may know that they are keyholders of other users, they may not know specifically which additional files they have been granted access to.

In some embodiments, as discussed above, the system may comprise an interview engine. Interview engine may comprise an application, service, server, daemon, routine, or other executable code for playing pre-recorded questions to a user, and recording the user's answer. Questions may include a large variety of topics ranging from life to food to culture or any other type and form of questions. Each question may be randomly selected, and may be open-ended in nature, encouraging the user to talk as much or as little as they wish. Users may also skip any question. By speaking about a random topic, many users are more likely to say something highly natural and feel less self-conscious. In some embodiments, the interview engine may concatenate recorded responses to questions into a long-duration media file, or may generate separate media files for each question response. The user may preview each of the one or more media files and publish them for view by other users. In a further embodiment, media files generated through the interview engine may be indexed in a list on the user's profile page.

In some embodiments, interview questions may also be chosen by the user, or the general category of the questions may be chosen by the user, or by a friend of the user to be sent to the user as a challenge, a game, or as a way of getting to know them better through asking them questions. For example, by allowing a first user to select one or more questions or general categories of questions to form an interview list to be asked of and responded to by another user, employers interviewing candidates for a potential position may utilize the interview system in a professional context. Similarly, the interview system may be used in a dating context by allowing users to send questions to potential dates to be answered prior to meeting. Because the answers to the interview may be in the form of user-generated videos or audio files, they allow the first user generating the interview list (e.g. employer or person seeking a date) to make a much better assessment of the other person via body language, tone, and personality. For example, sarcasm or dry humor readily apparent in a video may be lost in a purely-textual communication.

In addition to profile media files, a user may provide a short text description to appear under the user's name on their Profile page. In some embodiments, the text description may be displayed upon mouseover of the user's picture or avatar. Text descriptions may comprise names, occupations, companies, websites, quotes, hobbies, summaries, or other identifiers. In some embodiments, the text description may identify one or more tags for easier searching.

As discussed above, in many embodiments, a user may indicate they are a fan of or “like” another user. As a fan, the user will see the liked user's published and unlocked media files appear in their feed on their homepage. Additionally, a fan may become a keyholder, receiving access to additional media files of the liked user, if the liked user wishes to extend the fan the privilege. In one embodiment, only fans of a user may be granted keys by that user. Accordingly, being a fan may be a first step to becoming a keyholder. This encourages further social linking throughout the service.

As discussed above, in some embodiments, a first user may leave a “footprint” or traces on the profile of a second user, indicating that the first user viewed the second user's profile. The second user may receive a notification that the first user left a footprint on the page. The footprint may also be visible to other users, identifying the first user to any other viewer of the second user's profile. Footprints may last for a limited time, such as 48 hours. In another embodiment, a user may be limited from leaving multiple footprints within a predetermined time period on a second user's profile. This may prevent a first user from leaving dozens or hundreds of footprints on a second user's profile within a short time period, such as 48 hours. Users may, in some embodiments, block other users, preventing blocked users from leaving comments or footprints on the blocking user's profile or media files.

In some embodiments, the service may feature users, encouraging other users to become fans. This can provide additional exposure to viewers in a city, industry, region, social group, or other network. In one embodiment, if a first user chooses to ‘Be featured’ then their profile may appear in a section of the homepage for other users who match the first user's criteria. The first user may specify criteria of users to be featured to, including location, age range, education level, gender, industry, specified hobbies, or any other criteria. In some embodiments, the first user may further specify the number of times their profile may be shown to other users.

In some embodiments, the user may choose to feature one or more of his media files such as videos or pictures. In certain cases, the user may choose to whom and how frequently each one of his chosen clips will be featured. For example, a user may choose to feature clip #2 to female members in Boston aged 35 to 45 at a frequency of 50 times per day, and to feature clip #4 to members in Florida that happen to be lawyers aged 60 and above at a frequency of 100 times per day. If a media file is being featured, it may be displayed in a prominent position on a pages presented to other members, such as pages where other media may be viewed.

In some embodiments, a user may select one or more “sponsors” from a given list of companies and brands that are interested in having their logos, name brands or other identifiers be associated with the media being viewed and/or heard on the site. The brands, logos, or other identifiers chosen by the user may appear in conjunction with his or her media files. This allows users to decide which brands are associated with their image. In some embodiments, users may earn revenue, credits, or other forms of incentives and/or rewards in proportionate consideration of the viewership of their media files in association with the selected brands. For example, as a user's media file associated with Brand X is viewed more and more, the user may earn revenue or rewards in proportion with the number of views. In some embodiments, the proportion may be linear (e.g. one credit or 0.1 cents per view, or one credit per every 10 views, for example); may be stepped (e.g. 0 credits for the first 20 views, 1 credit for the next 20 views, 1 credit for the next 50 views, etc.); may be non-linear (e.g. one credit for every doubling of the number of views, such as 1 view, 2 views, 4 views, 8 views, etc.); or may be calculated in any other method. The brand or logo or other identifier of the company may, in certain embodiments, be encoded into the media file as to allow the media file to display the brand on all devices regardless of the players used by the device. For example, the brand or logo or other identifier may appear as a watermark or an on screen graphic, sometimes referred to as a digital-originated graphic, digital on-screen graphic, “bug” or “logo bug”. In certain embodiments, the users may choose the running time or duration or the number of views during which a particular brand may be associated with one or all of their media files. In other cases, the users may have no control over how long or which brands may be associated with their media files. In certain cases, a user may choose to stop the association with a brand based on his personal beliefs, preferences, interests, and taste. Such a customized selection of sponsors and advertisers will allow the system to be sensitive to user preferences and to advertise back to them products that are more in-line with their own preferences in addition to the basic profiling seen in today's advertising market. Accordingly, in many embodiments, the system may generate a report for said sponsors or advertisers, identifying the users or number of users associating the advertiser's logo with one or more media files, the demographics of said users, the number of views of said media files, or any other useful information.

In one embodiment, a featured user's profile may be displayed a predetermined number of times per day to other users matching the featured user's specified criteria. Each time the profile is shown may be referred to as one impression, and in some embodiments, the featured user may have a limited number of free impressions per day, such as ten. If the featured user wishes to be displayed to additional users, they may use credits to purchase additional impressions. In one embodiment, a user may accumulate credits every time the user has a new guest, host or fan as well as every time the user publishes a new media file or clip. For example, in one such embodiment, the user may earn credits at a rate of:
new fan: 1 credit
new guest: 5 credits
new host: 5 credits
new blog clip: 1 credit
new guest clip: 2 credits
new appearance: 3 credits
   Thus, users are encouraged to bring in additional users and provide additional content for the system. In some embodiments, credits may also be purchased, providing an additional revenue stream for the system operator.

Credits may be charged for additional impressions beyond the predetermined number of free impressions. For example, in one embodiment, a featured user can request to have their profile be shown to matching users up to the predetermined number of free impressions, or a higher number of times. In some embodiments, there may be no guarantee that a profile will be shown a particular number of times, as display of the profile is responsive to matching users being logged in. In some embodiments, requesting a higher number of display times may place the user's profile into a higher display priority over users who requested a lower number of display times. If the user's profile is displayed more than the predetermined number of free impressions, the user may be charged a predetermined amount, such as one credit per additional ten impressions. In some embodiments, the user's profile may be displayed an even greater number of times than they requested. In a further embodiment, the user may not be charged for such extra times, providing incentive to select a higher number through the increased priority without being penalized for popularity or frequent matching with other users.

In some embodiments, as discussed above, credits may be purchased. Accordingly, the service may comprise a billing system or may connect to a billing service provider such as PayPal or a similar service. In some embodiments, credits may be purchased for low prices, such as ten cents per credit, providing a predictable price for impressions and advertising.

It may be helpful to briefly discuss an exemplary embodiment of an application and web page for use with the systems and methods discussed herein. The following screenshots and discussion are only for illustrative purposes and are not intended to limit the scope of the claimed invention.

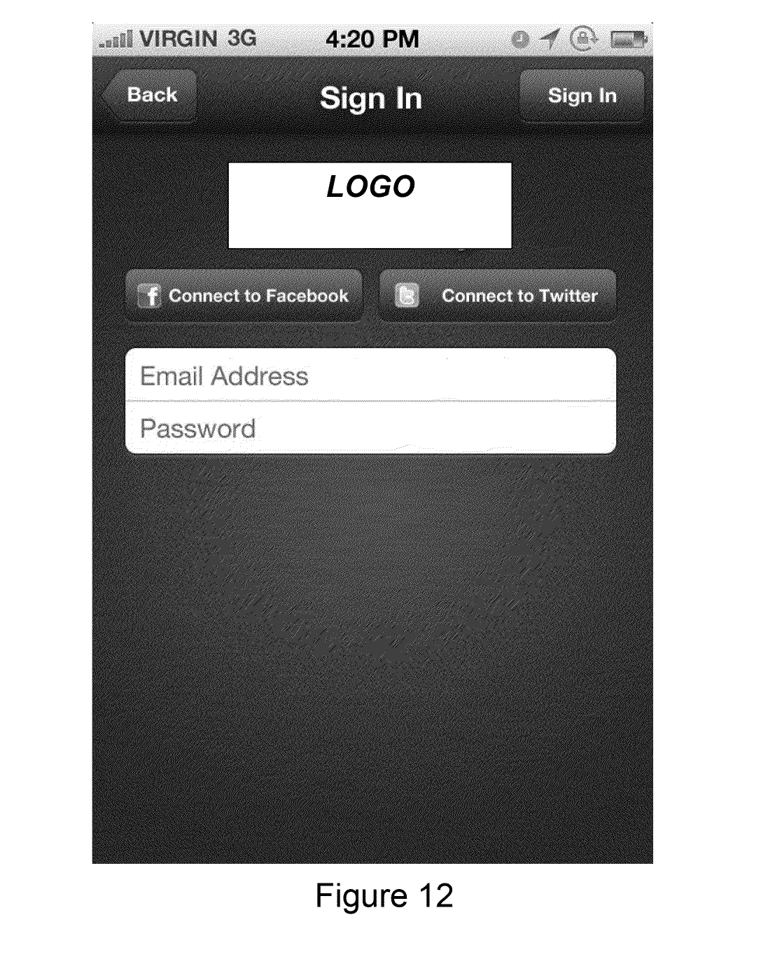

FIGS. 12-20 are screenshots of an example embodiment of an application for a mobile computing device for practicing the systems and methods discussed herein. Referring first to FIG. 12, a mobile application may include a sign on or authentication screen. A user may input authentication credentials, including email address, username and/or password. In some embodiments, as shown, the application may also allow login to a social networking site such as Facebook or Twitter, and use the user's login to the social networking site for simultaneous login to the multimedia social network system.

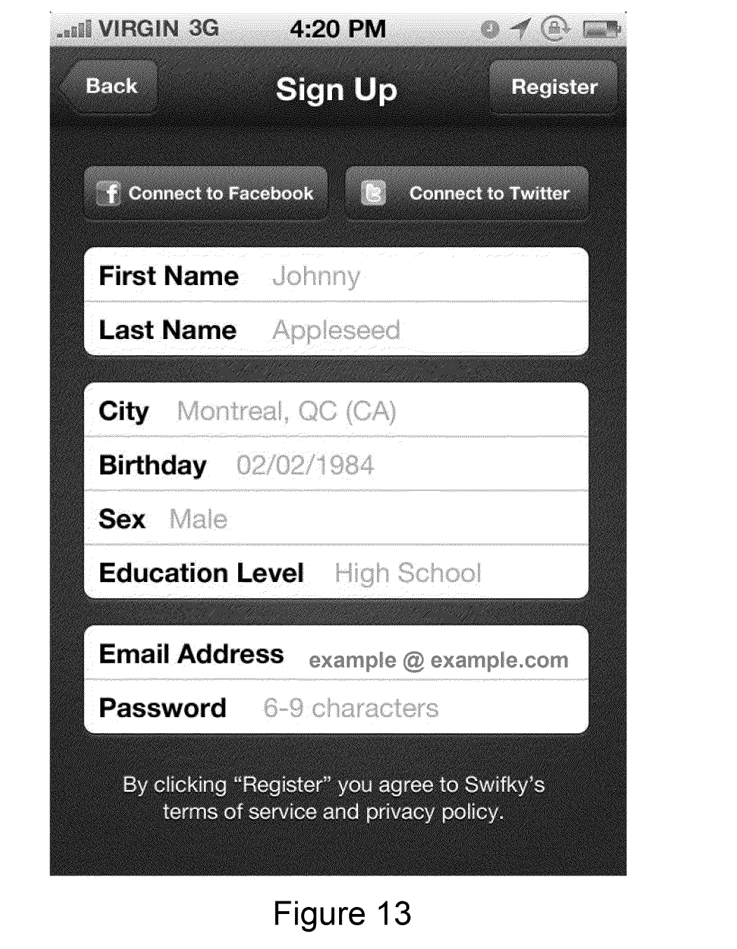

Referring now to FIG. 13, in some embodiments, a user may be directed to sign up or register for the service, such as if a user has attempted to log in via the screen in FIG. 12 and no account associated with the user's email exists. In other embodiments, the user may select to register a new account. During registration, the user may provide credentials including name, address or city, gender, date of birth, education level, industry, profession, title, household income, email address, password, or any other information.

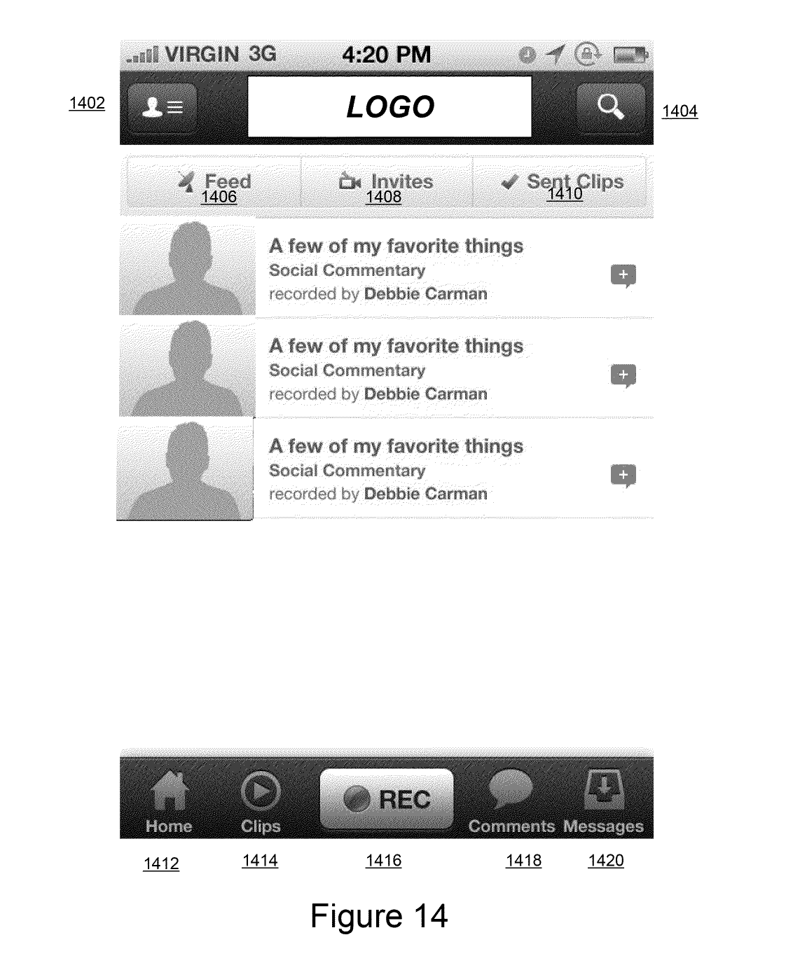

FIG. 14 is a screenshot of an embodiment of a homepage of the social networking site viewed on a mobile application. As shown, and as discussed above, a homepage may display the user's feed 1406 (i.e. user's broadcast, and broadcasts of guests, hosts, or fans). A button for accessing the feed may be displayed for consistency across screens. The homepage may provide access via one or more buttons to the user's profile page (1402), search page (1404), invites (1408), sent clips (1410), return to the default home page (1412), browse clips (1414), record a new media message (1416), view comments of other users (1418), or view private messages (1420).

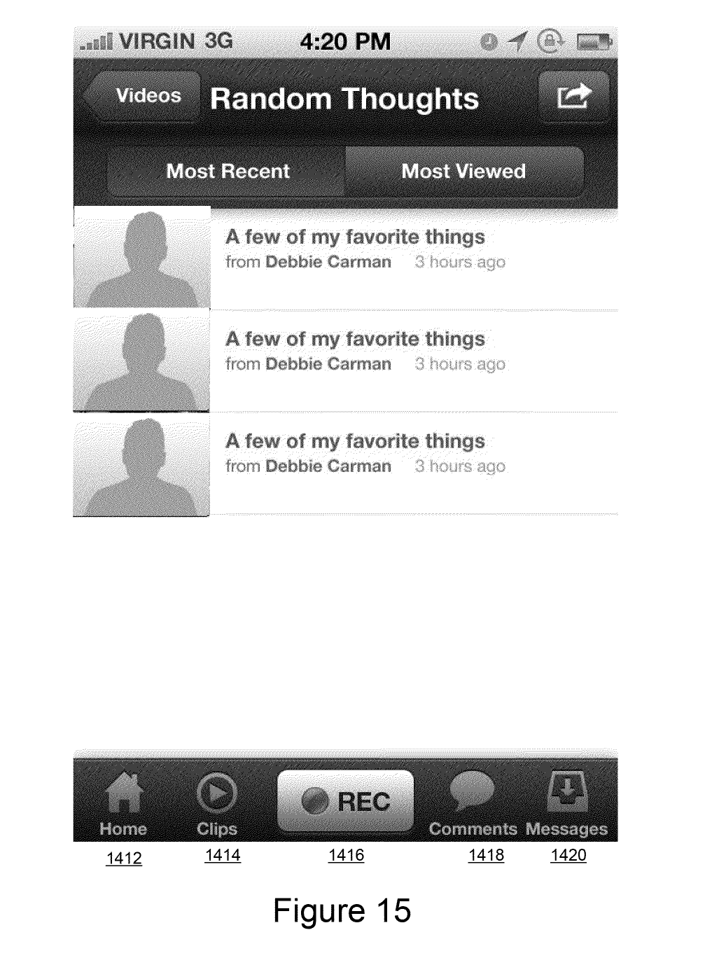

FIG. 15 is a screenshot of an embodiment of a list of clips, filtered by category. As shown, a user may select a category, such as “random thoughts”, and view a list of media files matching that category. The list may be sorted chronologically, by order of most viewed, or any other order.

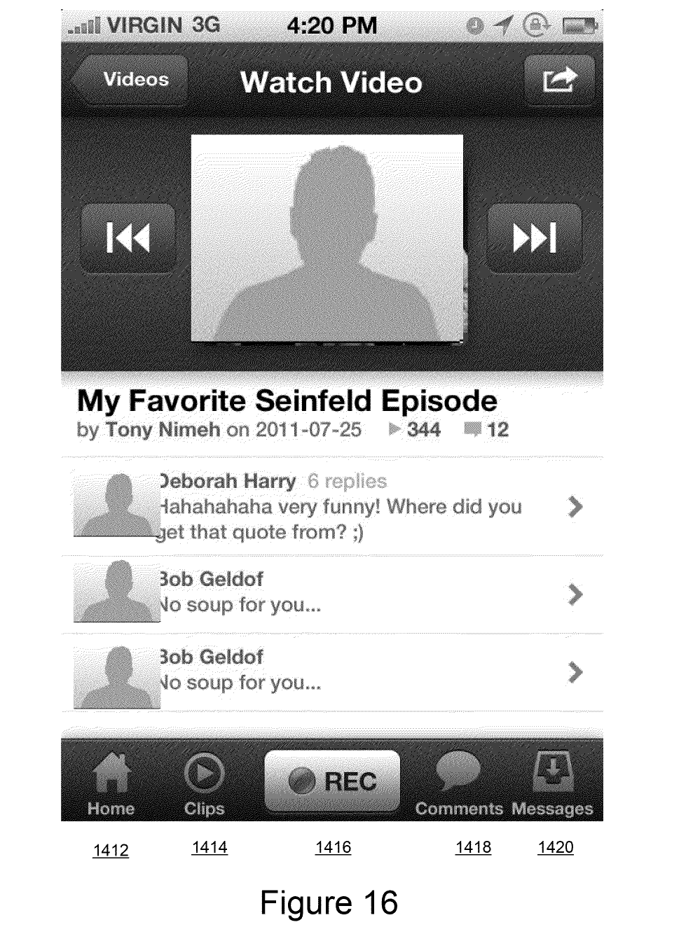

FIG. 16 is a screenshot of an embodiment of a post-playback landing screen, as discussed above. The landing screen may comprise a preview or still image from the media file, controls to replay the media file or skip to the next or previous media file in a viewed list, and one or more comments or replies left by other users. Comments may be text comments, or may be media files including audio comments or video comments. In some embodiments, additional details may be provided about the media file including owner, date, caption, number of times the media file has been played, and the number of times the media file has been commented on.

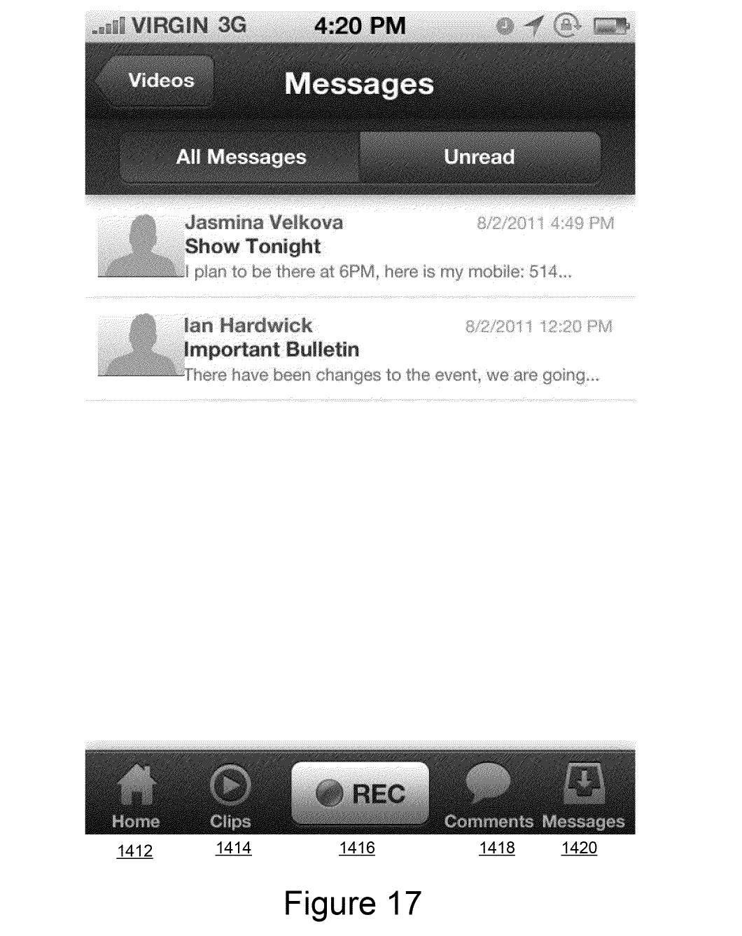

FIG. 17 is a screenshot of an embodiment of a private message page for a user. As shown, messages may comprise text, audio, and/or video, and may be sorted chronologically, by sender, by discussion thread, and unfiltered or filtered by unread messages.

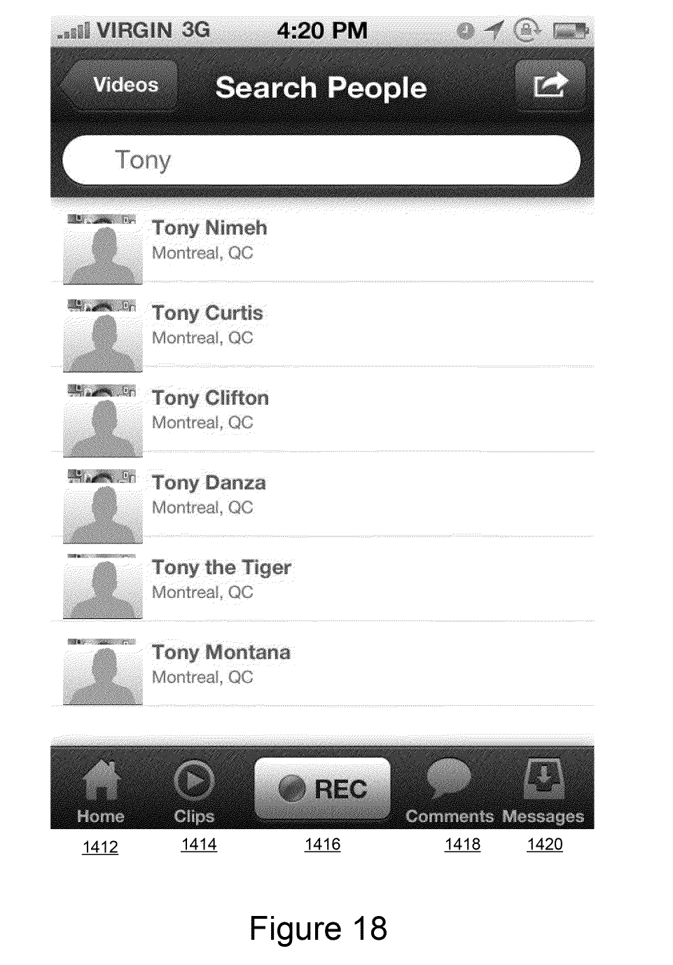

FIG. 18 is a screenshot of an embodiment of a page for searching for other users. In some embodiments, search results may be returned in real time. For example, as a user types in successive letters of a user's name, the application may display a matching subset of users. The user may, in some embodiments, select a search result to view the selected user's profile.

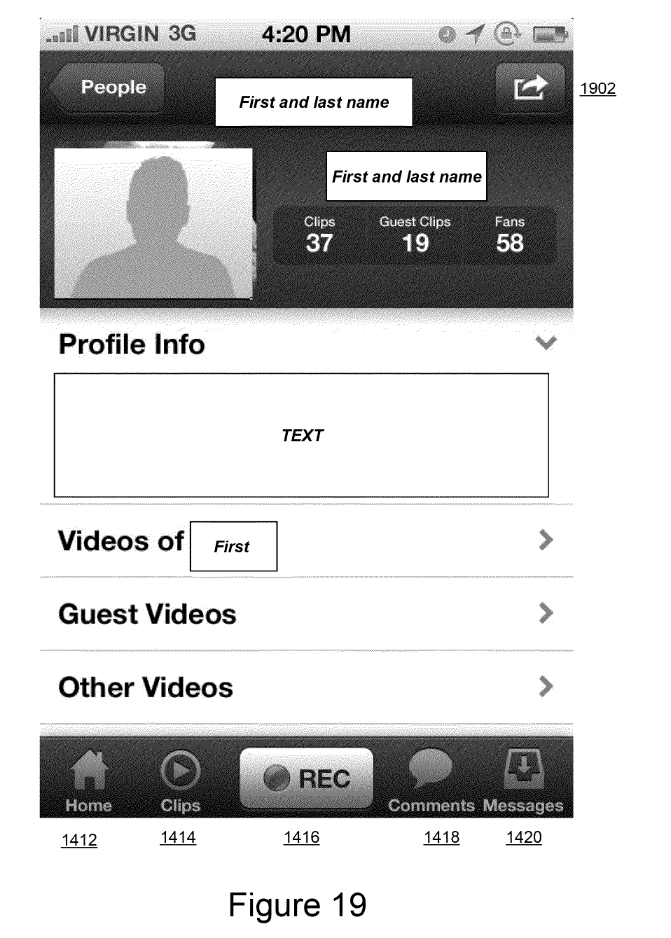

FIG. 19 is a screenshot of an embodiment of a profile page for another user. In some embodiments, a profile page may comprise a preview media file as discussed above, a description or biography of the user, a link to the user's website, and links to lists of the user's media files, appearances in others' media files, or media files the user has created of guests. In some embodiments, a profile page may further include a button (1902) for generating a private message to the user.

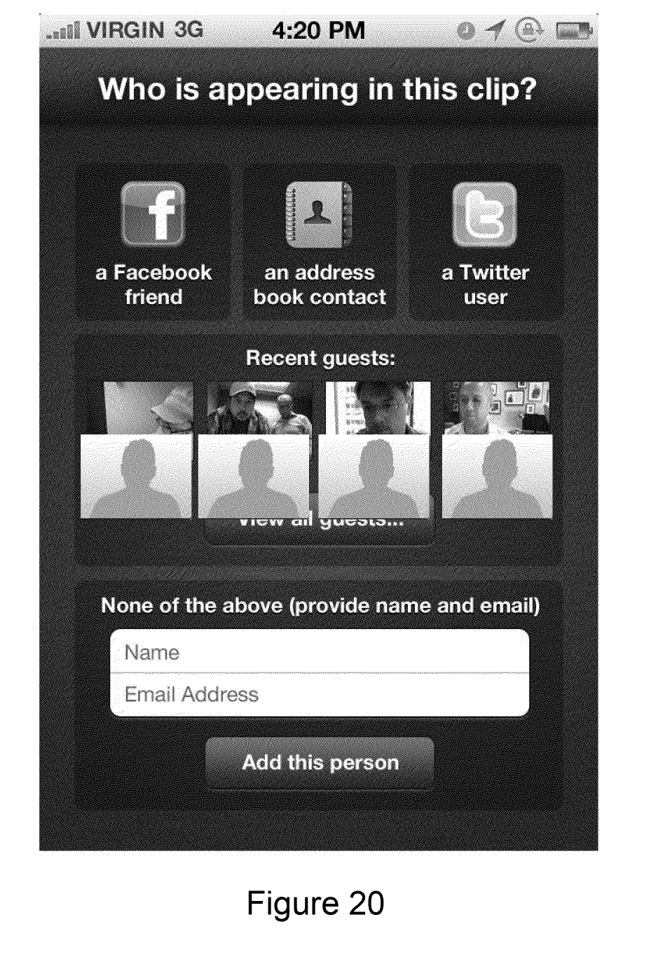

FIG. 20 is a screenshot of an embodiment of a guest identification screen after recording a media file of a guest. As discussed above, the originating user or host may select the guest from an identification of recently used guests, select the guest via an address book or social networking friend list, or may input the guest's name and email.

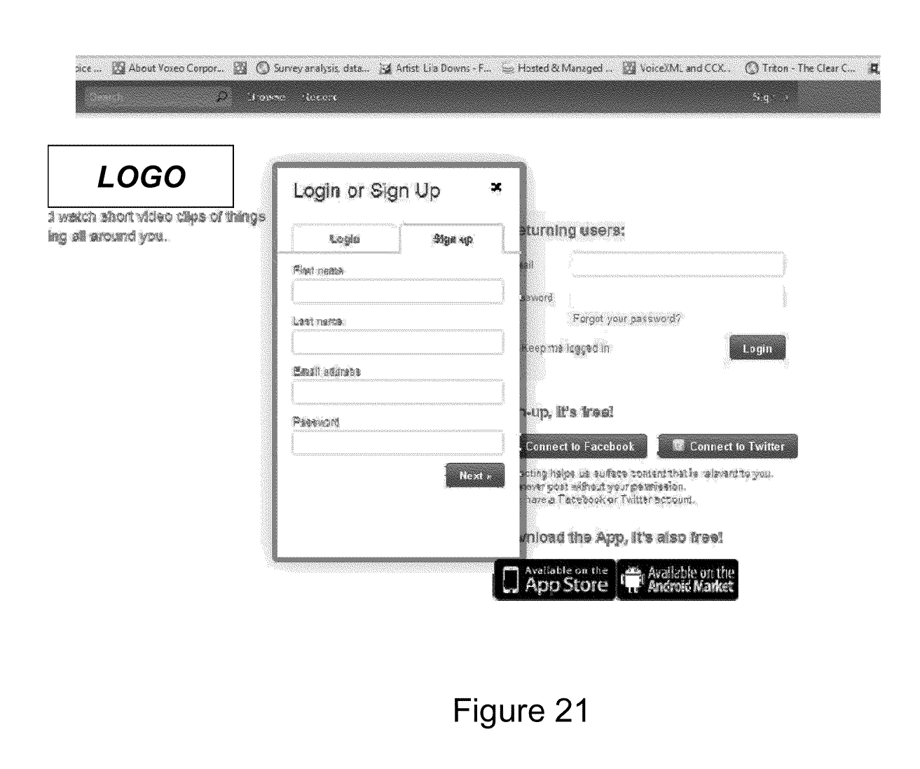

In addition to mobile applications, the systems and methods described herein may be presented via a desktop web browser. FIGS. 21-42 are screenshots of an example embodiment of a web page for a desktop computing device for practicing the systems and methods discussed herein. Again, the screenshots are for illustrative purposes only and are not intended to limit the scope of the claimed invention.

FIG. 21 is a screenshot of an embodiment of a login or signup popup. Although shown as a popup, in many embodiments, the login or signup window may be displayed within a webpage. The user may either log in to an existing member account or provide user credentials to register a new account. As discussed above, responsive to the user credentials provided, the system may generate a new inactive account or may activate an already-existing inactive account.

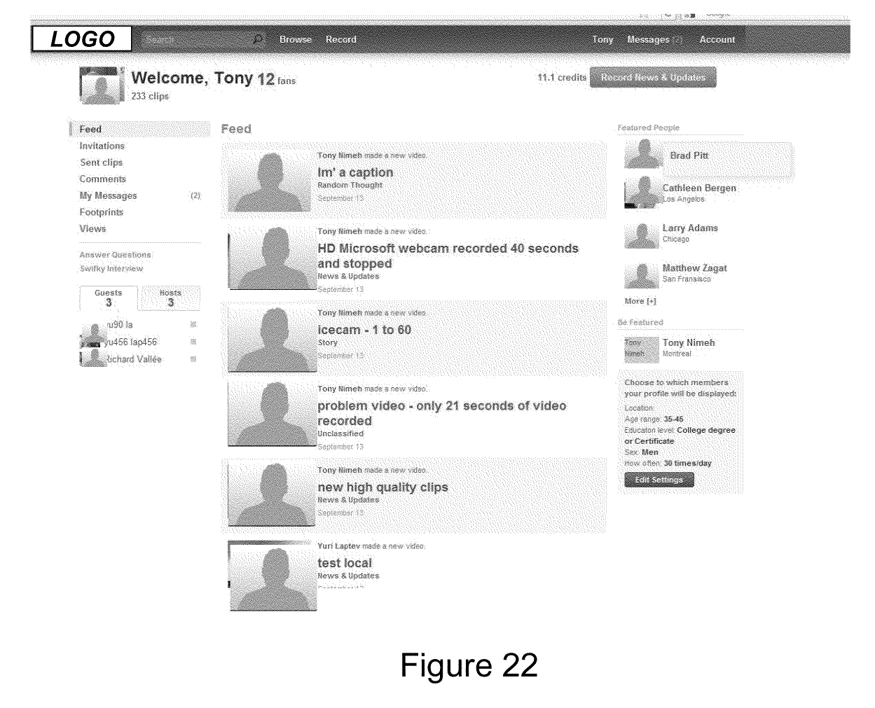

FIG. 22 is a screenshot of an embodiment of a user homepage. As shown, the user homepage may comprise a chronological feed of the user's media messages as well as messages of hosts, guests, and members of whom the user is a fan. In some embodiments, the homepage may display one or more featured users, as discussed above and visible on the right side of FIG. 22.

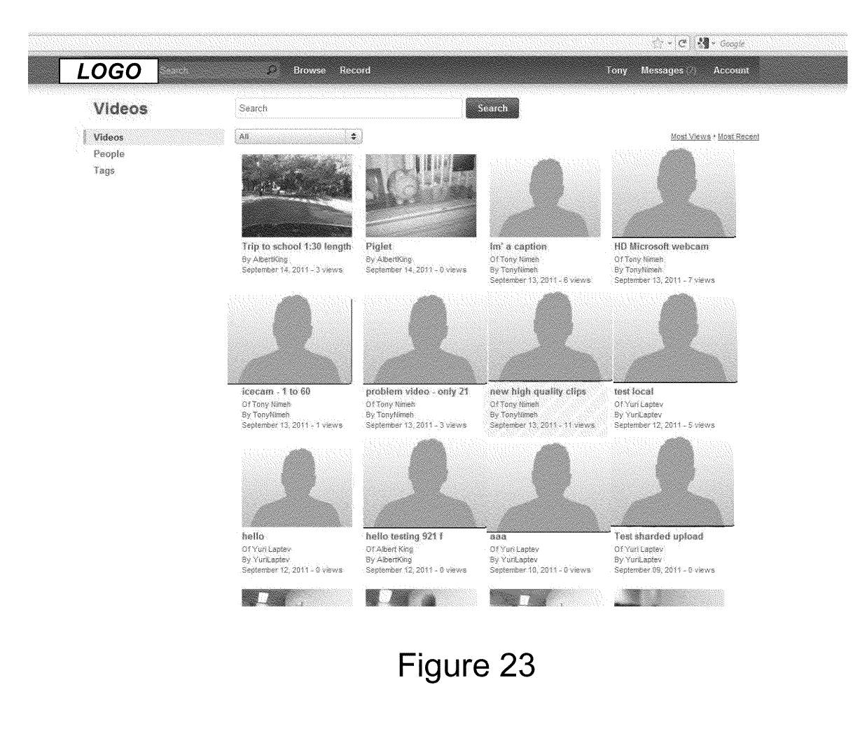

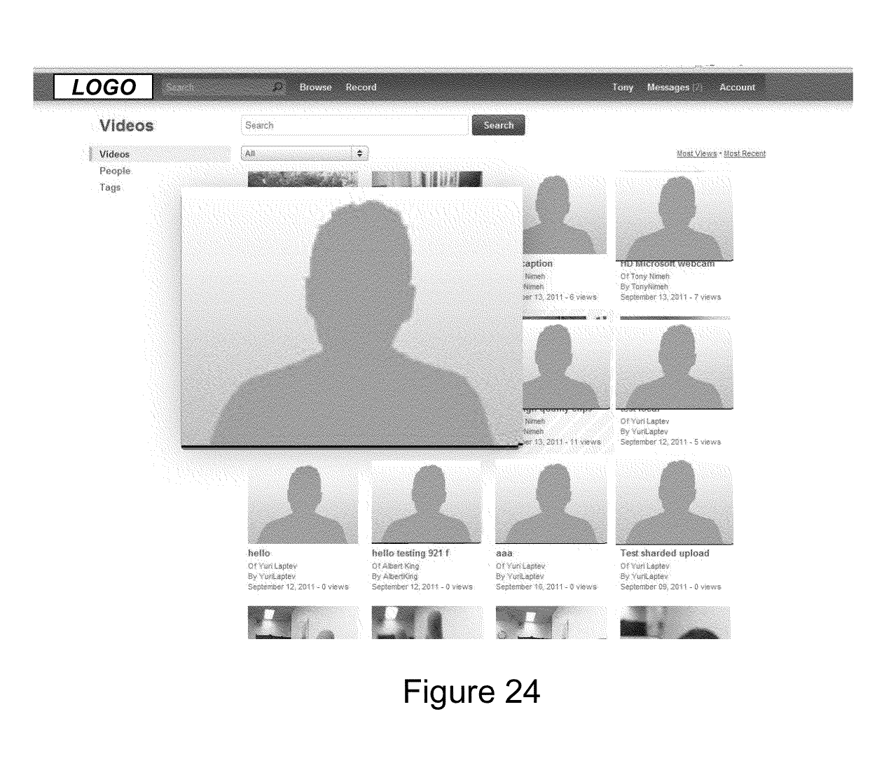

FIG. 23 is a screenshot of an embodiment of a media file browse and search page. In some embodiments, browsing and searching for media files may be combined, such that a search comprises a filter on the list of media files displayed. Media files may also be filtered by category. From the media file browse and search page, users may select a media file to view an automatically generated preview, as discussed above. FIG. 24 is a screenshot of an embodiment of a preview displayed in a pop-up window. In other embodiments, previews may be displayed in other windows or in a frame of the search window.

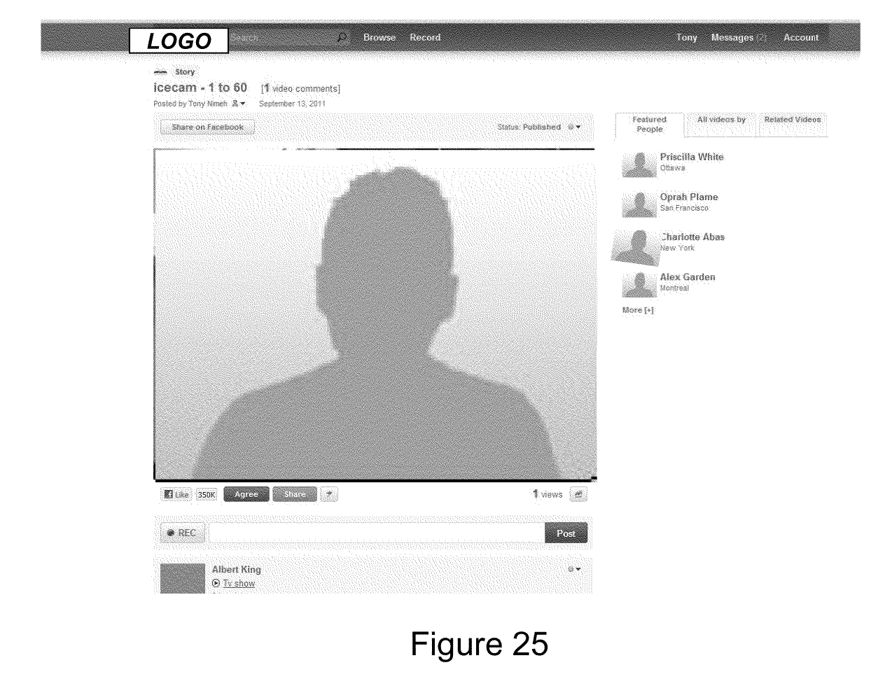

Once a user selects a media file, the media file may be shown in its own page, a screenshot of an embodiment of which is shown in FIG. 25. As shown, the user may play back the media file, leave comments on the media file, or view other media files by the member subject of the media file. In some embodiments, users can also engage in moderation of media files, by agreeing with media files to “upvote” the file, or by flagging the file for inappropriate or offensive language or images.

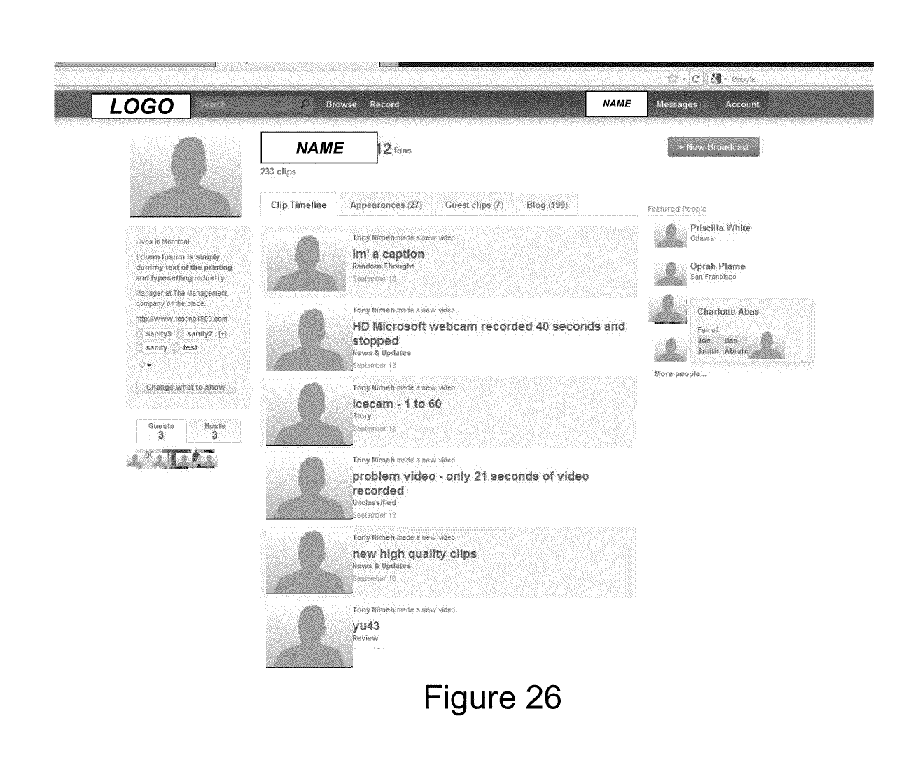

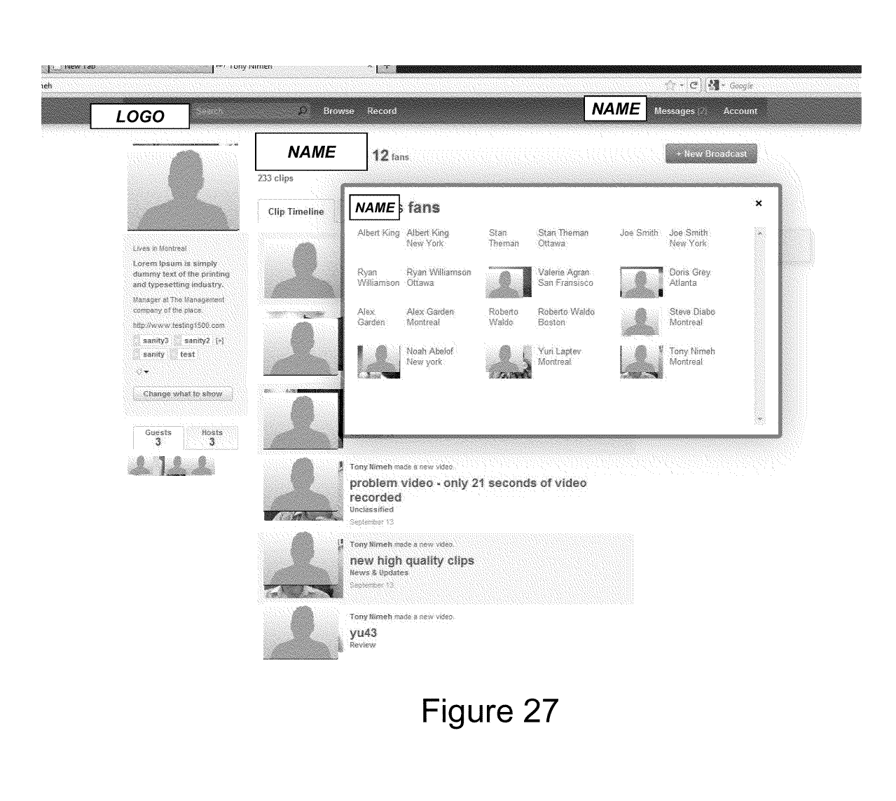

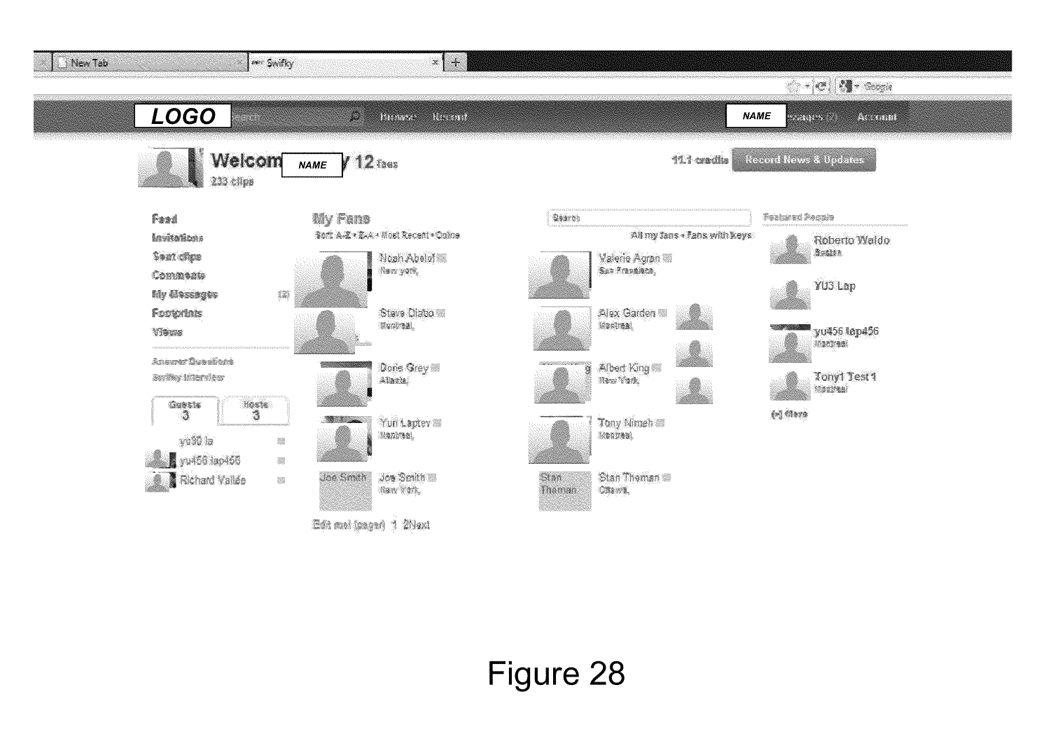

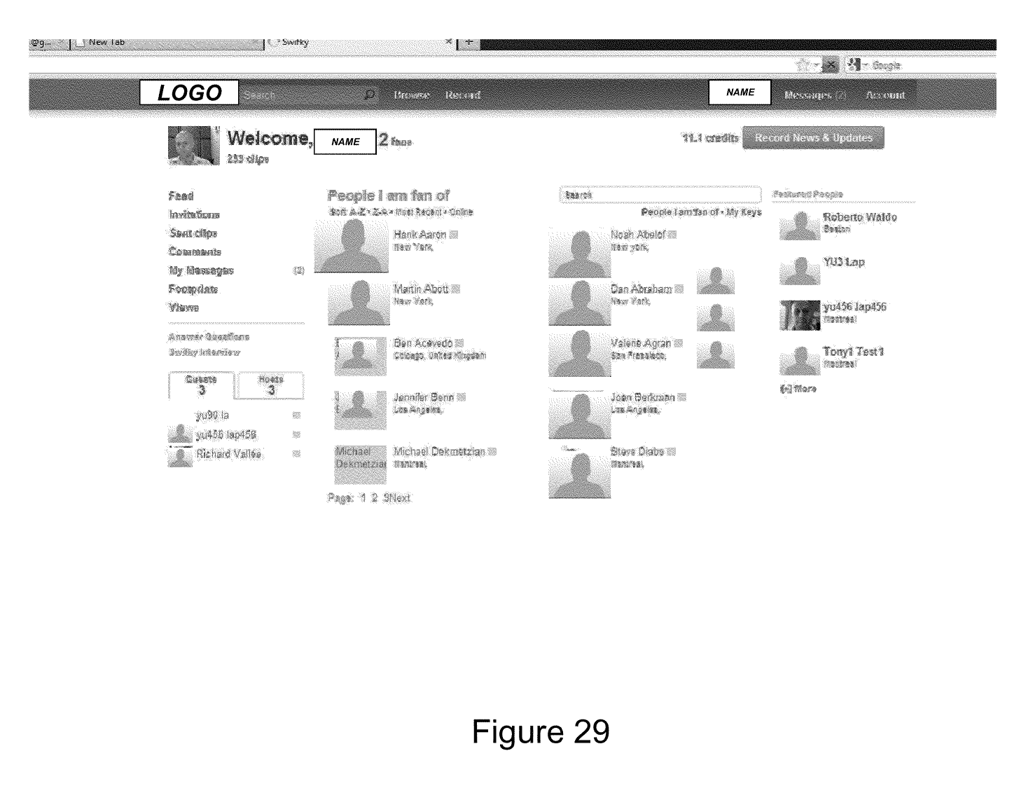

FIG. 26 is a screenshot of an embodiment of a member profile page. As shown, the member may have a profile media file associated with their account, which a user may select to view in a pop-up or another window. The profile page may comprise a chronological list of the member's media files, appearances, blog posts, clips, comments, or other interactions with the service. In some embodiments, a profile page may include an identification of the member's fans. A user may select the identification to view a list of the fans. A screenshot of an embodiment of a list of fans is shown in FIG. 27. In another embodiment shown in the screenshot of FIG. 28, the list of fans may be displayed within a web page. Similarly, as shown in FIG. 29, the user may view a page comprising a list of other members the user is a fan of.

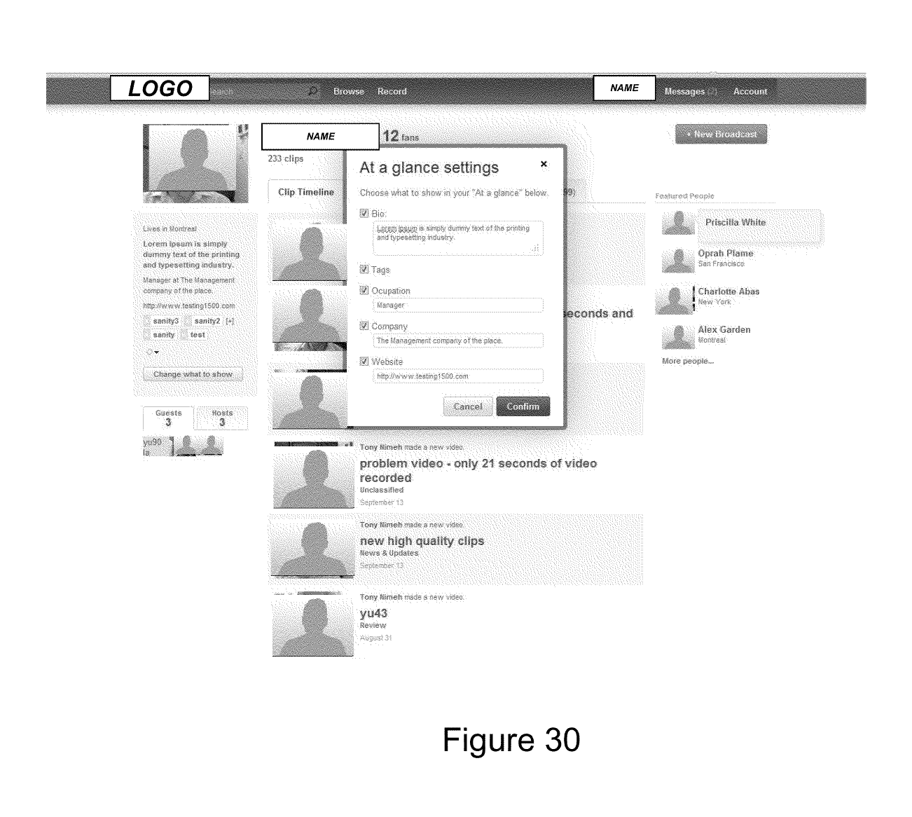

In some embodiments of a member profile page, a short description, biography, summary, or “at a glance” description may be displayed to other users. The description may also be provided as an alt tag or mouseover text elsewhere within the service. As shown in the screenshot of FIG. 30, in some embodiments, the member may edit their description and include a biography, profession, industry, company, web page, and one or more tags to aid in searching and filtering user selections.

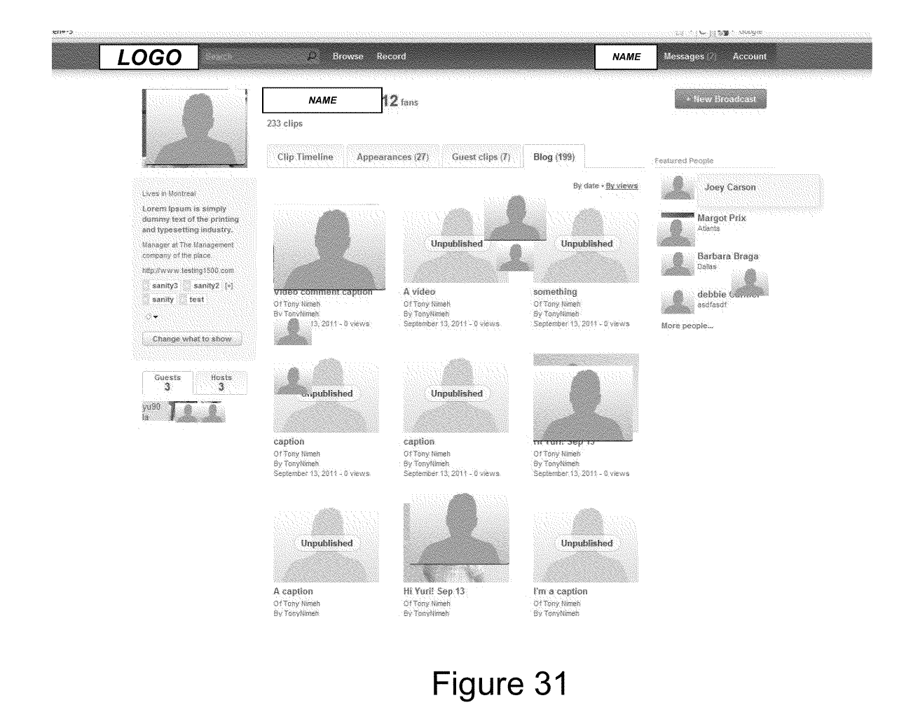

FIG. 31 is a screenshot of an embodiment of a list of a user's blog media files. As shown, media files may be published or unpublished. In the example screenshot shown, the user is viewing their own profile page—accordingly, unpublished media files are visible to the user. If the user was viewing another member's profile page, any unpublished files would not be visible.

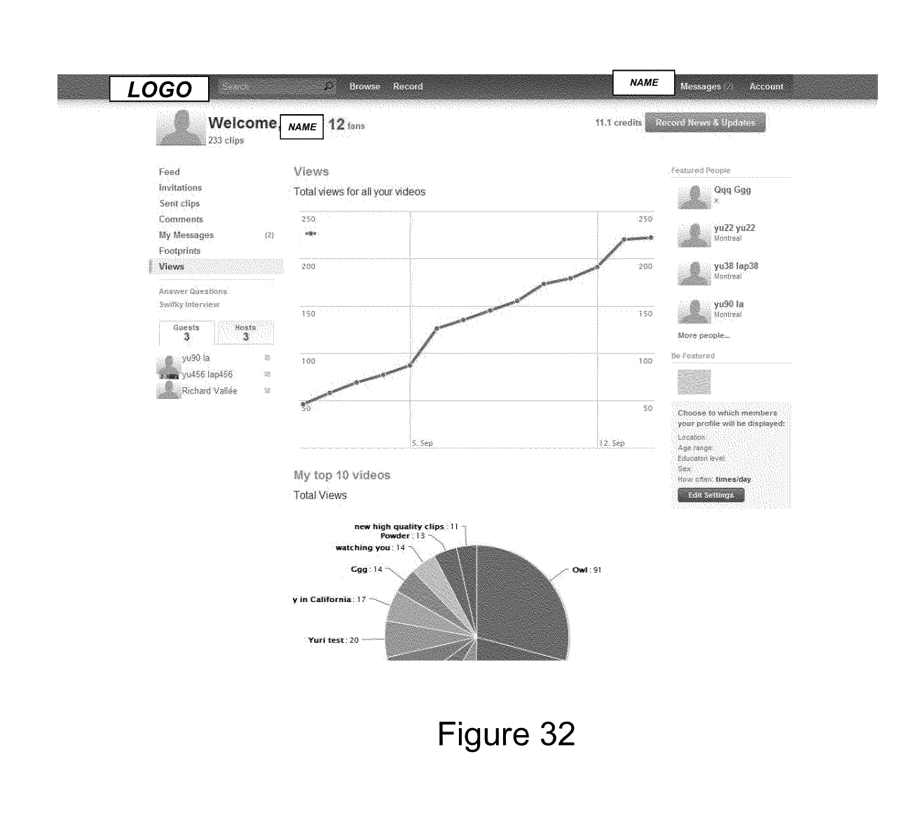

In some embodiments, a user may view statistics related to the user's videos. For example, as shown in the screenshot of FIG. 32, in some embodiments, the user may select to view a graph of views over time of the media file or the total of all views of the user's media files, as well as a chart or list of the most-viewed media files of the user.

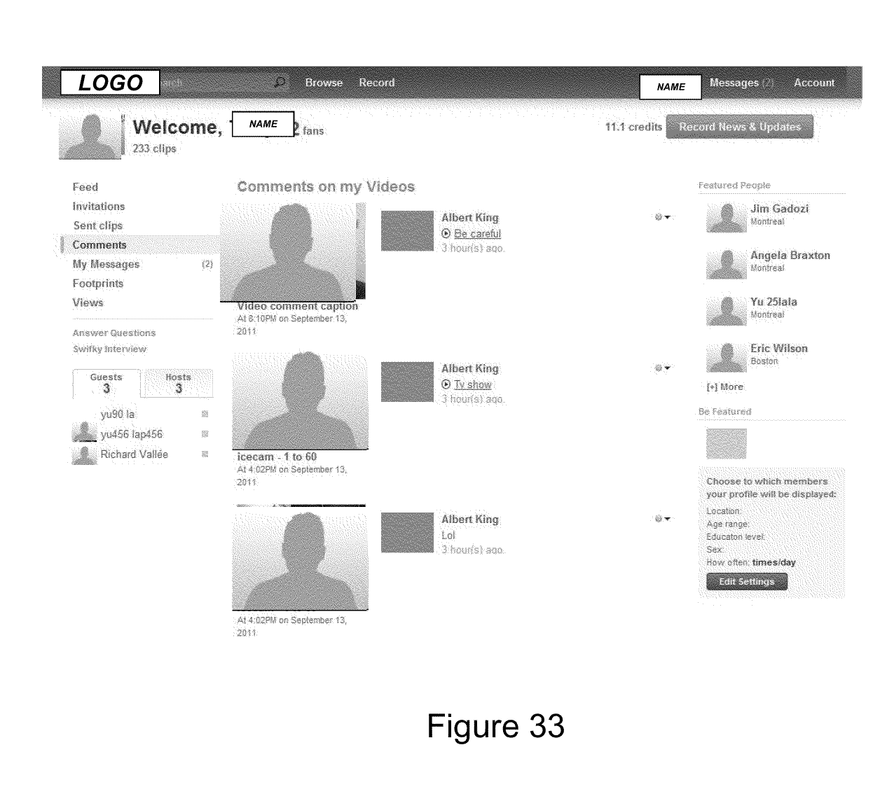

FIG. 33 is a screenshot of an embodiment of a page displaying comments on a user's media files left by other members. In many embodiments, the comments may be sorted chronologically, and may be threaded by discussion or the user's media file which each comment is associated with.

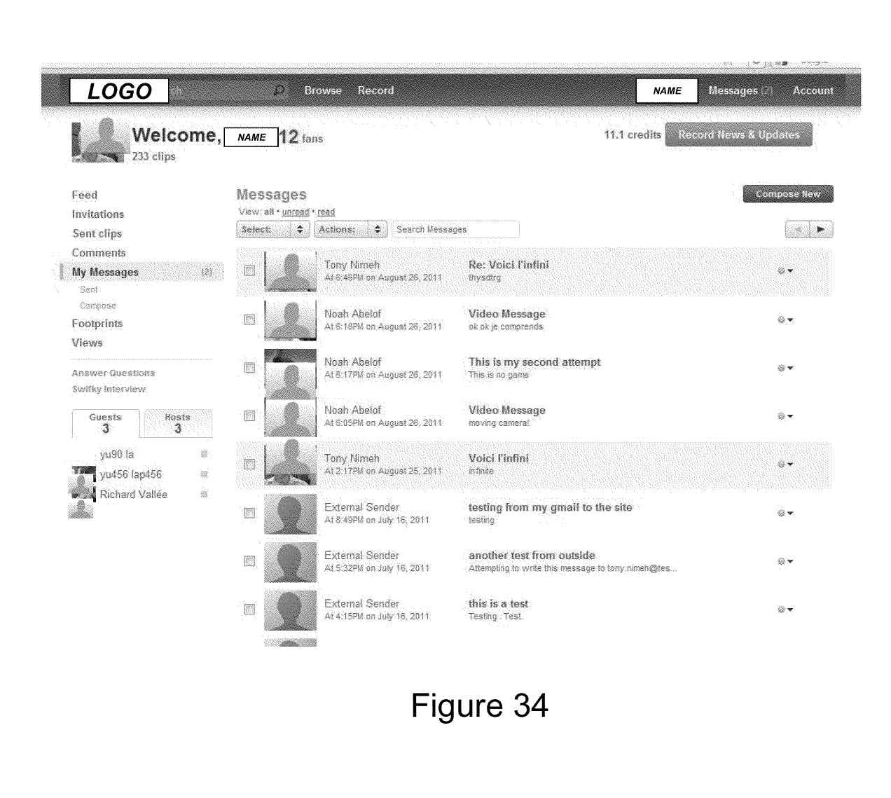

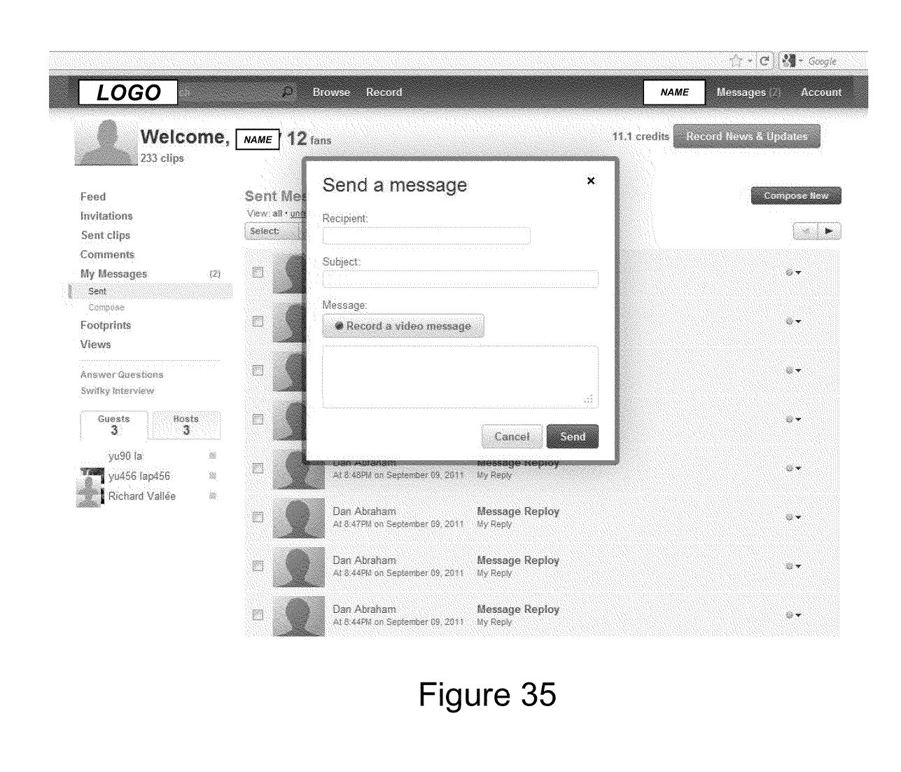

FIG. 34 is a screenshot of an embodiment of a page displaying private messages for a user. In some embodiments, messages may be sorted chronologically, or may be threaded by conversation. As shown in FIG. 35, in some embodiments, the user may select to send a private message to another user. As discussed above, private messages may comprise text, audio, video, and/or still images.

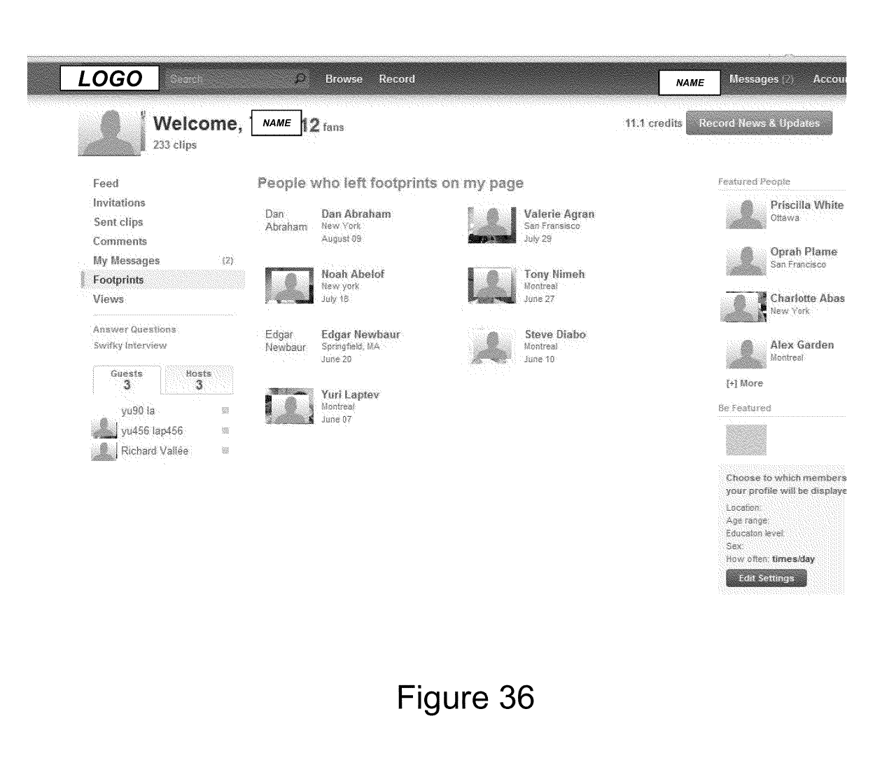

As discussed above, users may leave footprints on another member's profile page. FIG. 36 is a screenshot of an embodiment of a profile page displaying footprints left by other users. A member may click on a footprint to view the leaving member's profile media file, their profile page, and/or leave them a private message or footprint in return.

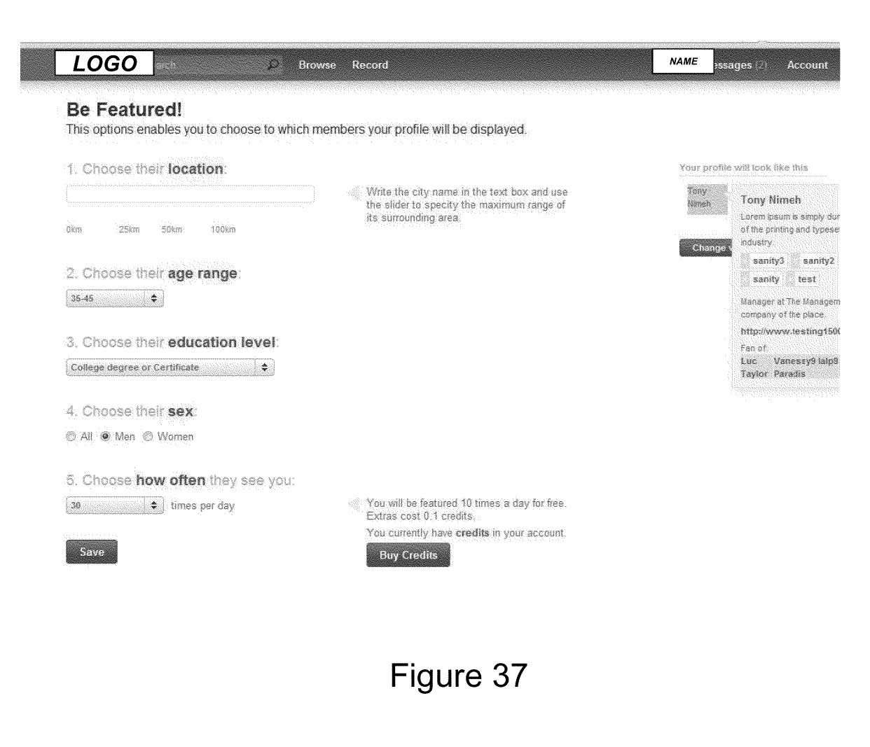

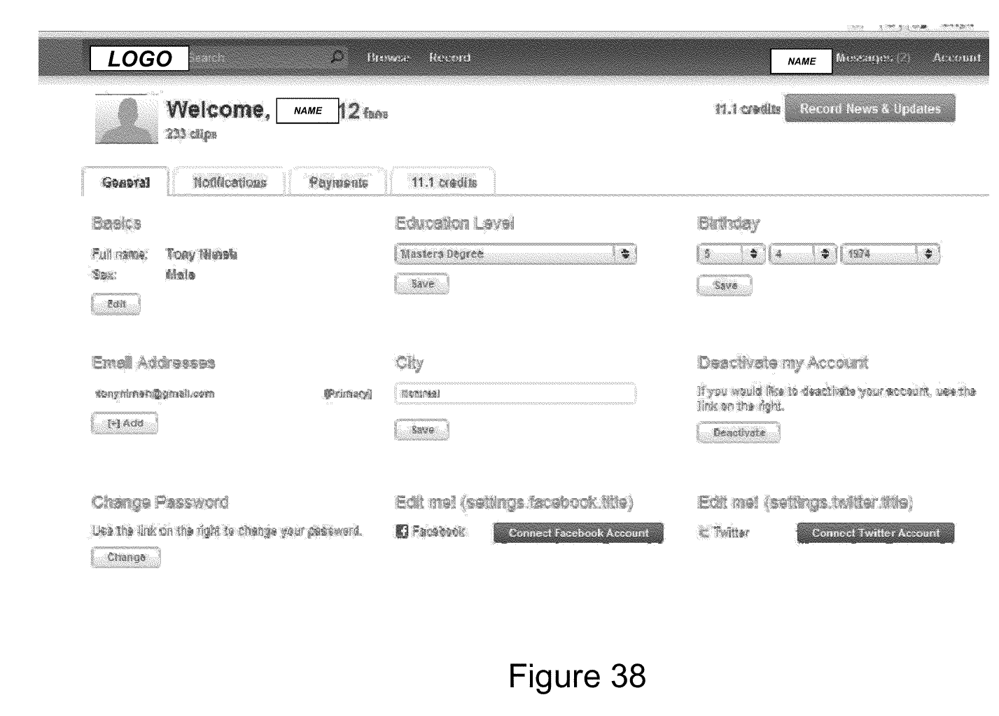

As discussed above, users may opt to become featured users. Illustrated in the screenshot of FIG. 37 is an embodiment of a signup page to become a featured user. The user may specify criteria of members that may be interested in the user, or members to whom the user's profile should be displayed. As shown in the screenshot of FIG. 38, in many embodiments, the criteria may be modified at a later time.

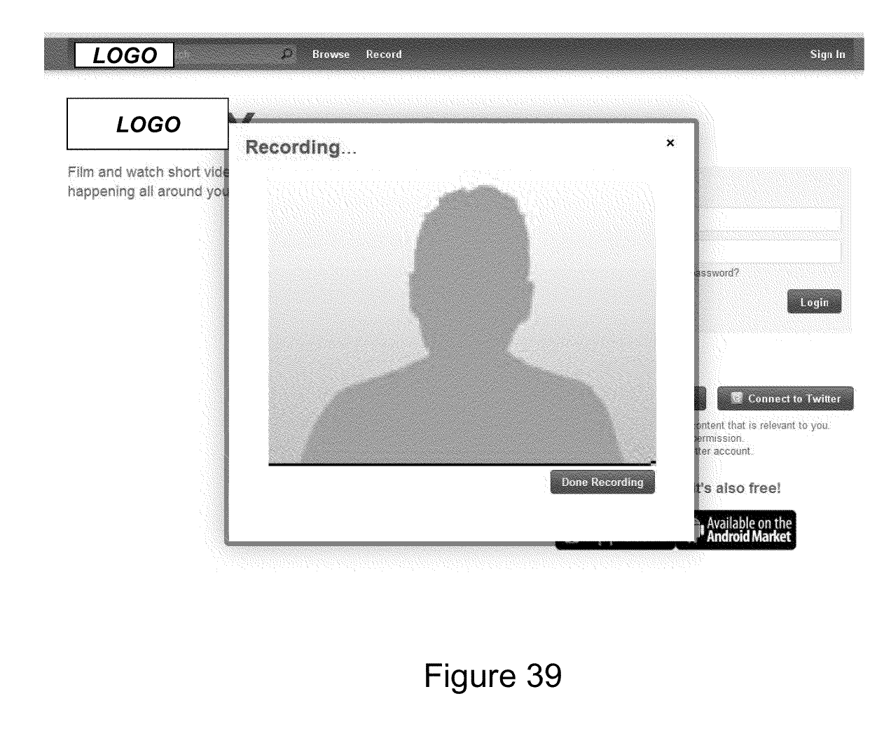

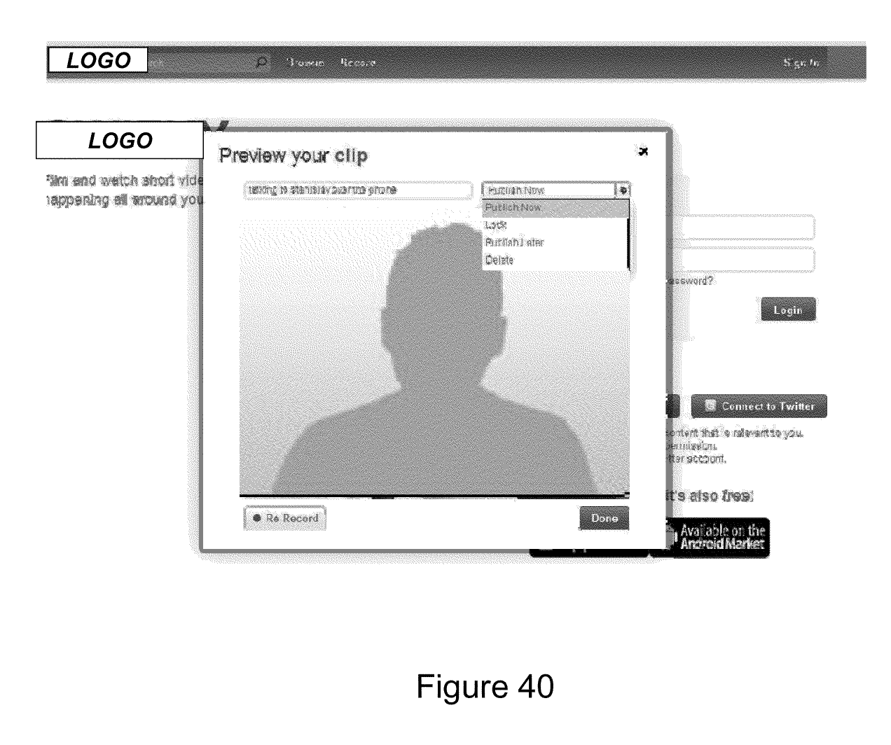

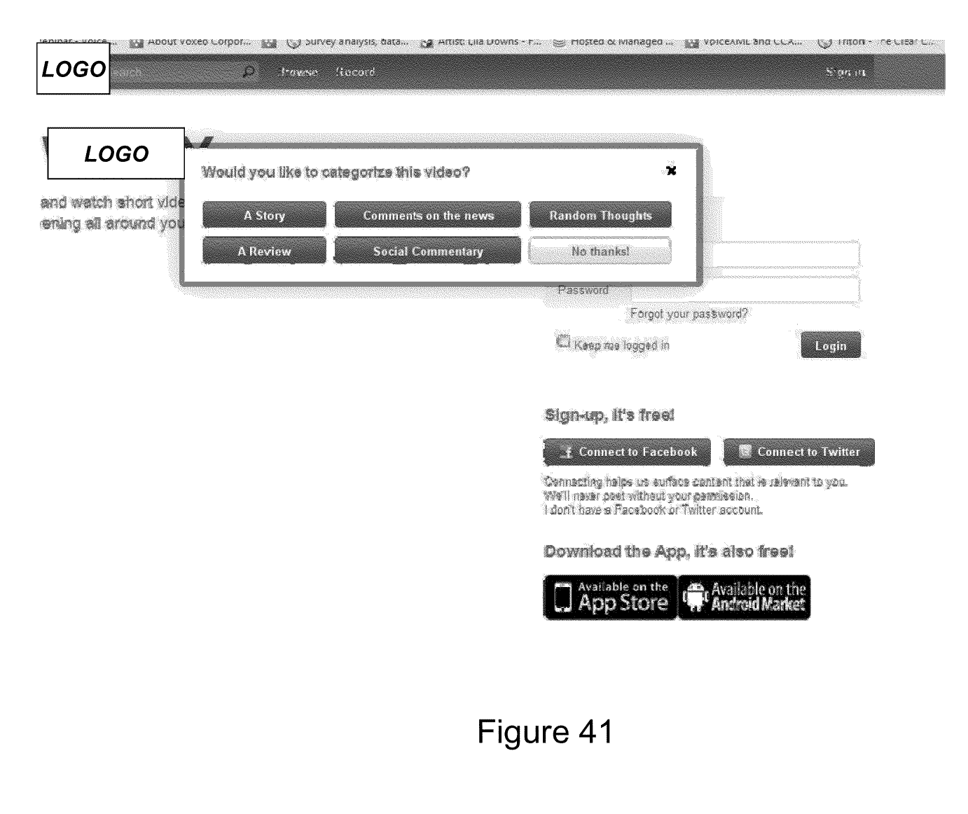

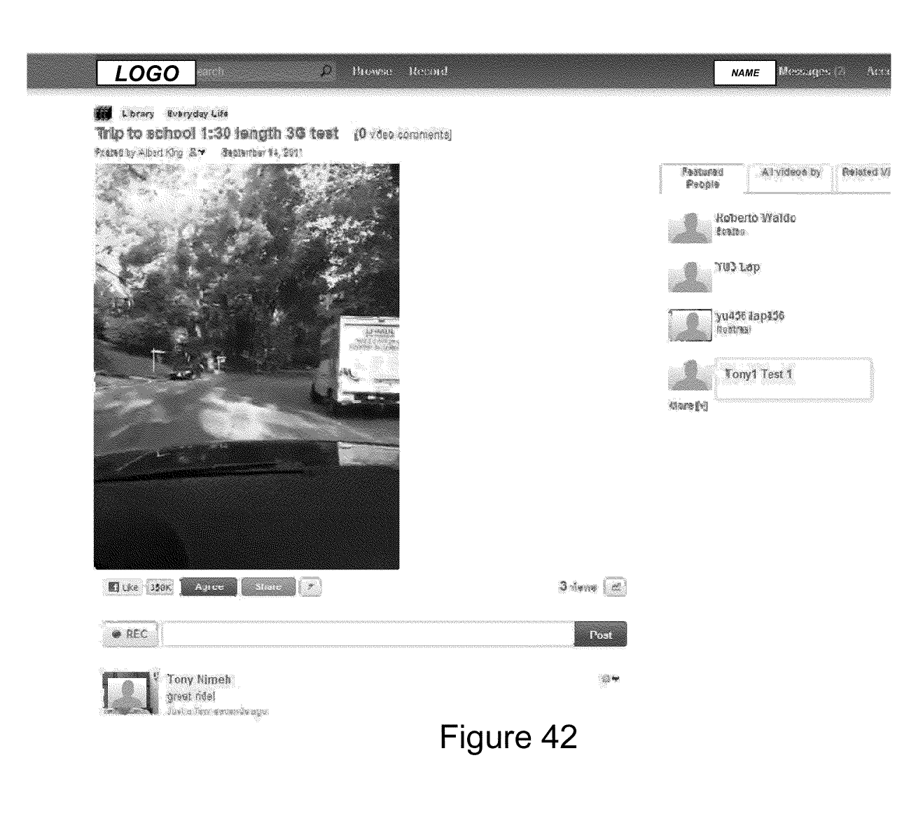

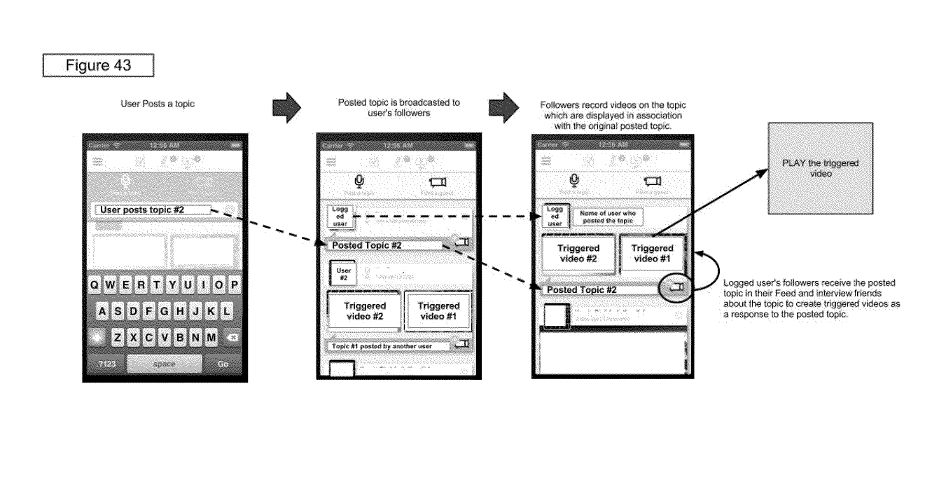

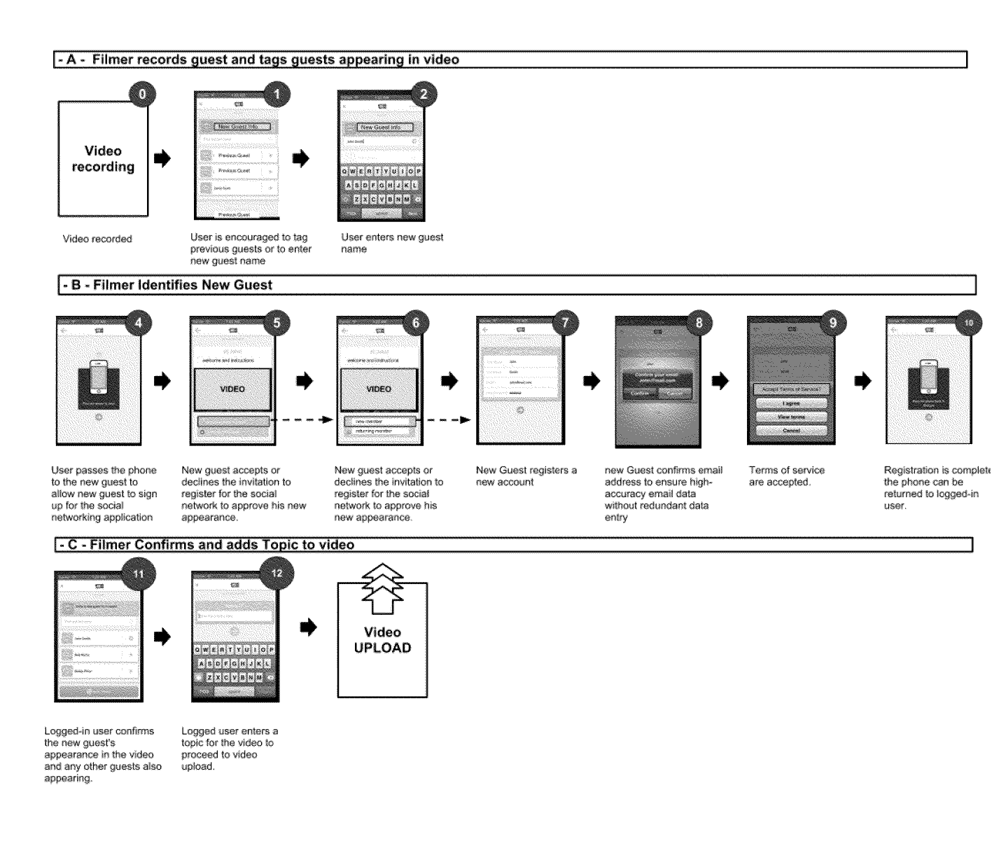

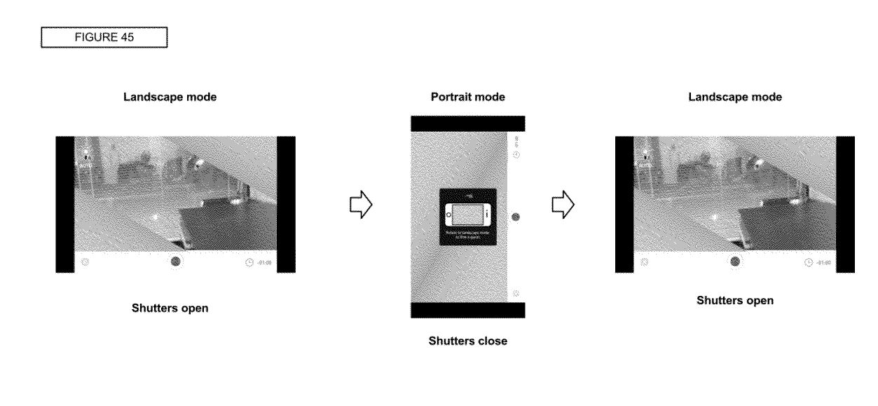

FIG. 39 is a screenshot of an embodiment of a recording window. In many embodiments, the recording window may be presented in a pop-up fashion to allow the user to interact with the content of the page without leaving the page. Accordingly, the recording process may be seamless and allows the user to interact with and in the context of the page, as opposed to an isolated activity that must be performed separately. This allows users to use video and/or audio recording as a tool to express themselves in any context without leaving the context that prompted the interaction. In some embodiments, the recording window may execute a script or plug-in, such as Flash, initiating a recording from the user's computing device's camera and/or microphone. The recording may, in some embodiments, be limited to a predetermined duration or may be manually stopped by the user. As shown in the screenshot of FIG. 40, in many embodiments, the user may review and discard or approve the recorded media file for publishing. Prior to publishing, as shown in the example screenshot of FIG. 41, the user may select a category for the media file. Once published, the media file may be viewed by other members and commented on, as shown in the example screenshot of FIG. 42.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed:

1. A system for social networking media system, the system comprising:
a web server receiving an upload of a recorded media message comprising video and/or audio, via a computing device of a user
wherein the web server provides the media message for review by one or more or other users;
wherein the web server receives an upload of a recorded reply media message via a second computing device of a second user; and
wherein the web server links the recorded media message and recorded reply media message to provide an interactive media-based asynchronous dialogue
